(19) United States
(12) Patent Application Publication
(10) Pub. No.: US 2011/0099185 A1
(43) Pub. Date: Apr. 28, 2011

(54) System for Querying and Consuming Web-Based Data and Associated Methods

(75) Inventors: Jonathan Trevor, Menlo Park, CA (US); Joshua Gordineer, San Jose, CA (US); Sam Pullara, Los Altos, CA (US); Paul Donnelly, Menlo Park, CA (US); Nagesh Susarla, Fremont, CA (US)

(73) Assignee: Yahoo! Inc., Sunnyvale, CA (US)

(21) Appl. No.: 12/607,804

(22) Filed: Oct. 28, 2009

(51) Int. Cl. G06F 17/30

(52) U.S. Cl. 707/756; 707/736; 707/E17.108

(57) ABSTRACT

A web data source includes data to be queried. A query language (QL) web service is defined to expose a QL for specification of the web data source and one or more operations to be performed on the web data source. Requirements specific to the web data source for accessing and performing operations on the web data source are abstracted through the exposed QL. A QL table is associated with the web data source. The QL table is accessible through a universal resource locator (URL). The QL table includes binding data which binds the web data source to the QL web service. The binding data includes instructions to the QL web service with regard to creating URLs to access and retrieve data from the web data source.

### CROSS-REFERENCE TO RELATED APPLICATIONS

This application is related to U.S. patent application Ser. No. ______ (Attorney Docket No. YAHOP096/Y05810US00), filed on even date herewith, and entitled “Developer Interface and Associated Methods for System for Querying and Consuming Web-Based Data,” which is incorporated herein by reference in its entirety.

### BACKGROUND OF THE INVENTION

In today's web (internet) universe, there exist thousands of web services and web data sources that provide valuable data. The various web services and web data sources can be defined using many different data types and formats, which can be either loosely structured or well structured. For example, web data sources may exist in formats such as HTML, XML, JSON, RSS, Atom, microformat, among others. In order for an application developer (developer) to access and utilize data from a given web service/data source, the developer is required to have a detailed understanding of the given web service/data source implementation, such as its particular data types and formats. This can require a developer to spend copious amounts of time learning a particular web service/data source implementation, which can hinder application development.

Additionally, the numerous available web services/data sources can exist in isolation. This requires the developer to perform separate and multiple processes to access and utilize data from multiple web services/data sources. Moreover, the developer may only be able to access data from a given web service/data source in its entirety, which will often require the developer to filter, combine, tweak, and/or shape data following its retrieval from a given web service/data source.

In view of the foregoing, there is a need for improved systems and methods by which a developer can access and utilize data from multiple and diverse web services and web data sources.

### SUMMARY OF THE INVENTION

In one embodiment, a system is disclosed for querying web data. The system includes a web data source including data to be queried. The system also includes a query language (QL) web service defined to expose a QL for specification of a query statement (QL statement). The QL statement specifies the web data source, data to be queried from the web data source, and one or more operations to be performed on the web data source. Requirements specific to the web data source for accessing and performing operations on the web data source are abstracted through the exposed QL. The system further includes a QL table associated with the web data source. The QL table is accessible through a universal resource locator (URL). The QL table includes binding data which binds the web data source to the QL web service. The binding data includes instructions to the QL web service with regard to querying the web data source for specific data present at the web data source.

In another embodiment, a method is disclosed for querying web data. The method includes an operation for generating a query language (QL) statement defined to identify one or more QL tables respectively associated with one or more web data sources, and to specify one or more actions to be performed on the one or more web data sources. The QL statement is formatted in accordance with a QL syntax. The method also includes an operation for embedding the generated QL statement within a universal resource locator (URL) directed to a QL web service. The URL directed to the QL web service is executed within an Internet browser such that the QL statement embedded in the URL is executed by the QL web service.

The method continues with processing the QL statement through the QL web service, whereby the QL web service accesses the one or more QL tables identified in the QL statement through the Internet and retrieves direction from the one or more QL tables regarding access and retrieval of data from the one or more web data sources respectively associated with the one or more QL tables identified in the QL statement. Based on the direction retrieved from the one or more QL tables, the QL web service is operated to access the one or more web data sources respectively associated with the one or more QL tables and perform the one or more actions on the one or more web data source as specified in the QL statement. The method further includes an operation for conveying a result of the one or more actions performed on the one or more web data sources by the QL web service to the Internet browser in which the URL directed to the QL web service was executed.

In another embodiment, a method is disclosed for binding web data to a web data query system. The method includes an operation for creating a structured file that includes information to bind a web data source to the system for querying web data. The information in the structured file includes authentication and security specifications indicating a type of authentication required for the web data query system to access the web data source, and indicating whether or not the web data query system is required to access the web data source over a secure connection. The information in the structured file also includes instructions for how the web data query system should create universal resource locators (URLs) that access data available from the web data source. The method also includes an operation for associating a URL with the structured file to enable access of the structured file through the Internet. The method further includes an operation for storing the structured file on a computer readable storage medium such that the structured file is accessible through the Internet by way of the URL associated with the structured file.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 shows a table of query parameters [query_params] for the URLs of the QL Web Service, in accordance with one embodiment of the present invention;

FIG. 2 shows a table of QL statements that can be submitted to the QL Web Service via the query parameter [q=] in the URL of the QL Web Service, in accordance with one embodiment of the present invention;

FIG. 3 shows a table of possible comparison_operator parameters that can be specified between the field and literal parameters, in accordance with one embodiment of the present invention;

FIG. 4 shows a table of possible QL functions that can be appended to a QL SELECT statement, in accordance with one embodiment of the present invention;

FIG. 5 shows a table which identifies whether an element in a QL SELECT statement is processed locally or remotely, in accordance with one embodiment of the present invention;

FIG. 6 shows the basic structure of the XML formatted output data in the response generated by a call to the QL Web Service, in accordance with one embodiment of the present invention;

FIG. 7 shows the basic structure of the JSON formatted output data in the response generated by a call to the QL Web Service, in accordance with one embodiment of the present invention;

FIG. 8 shows a table that lists the attributes of the query element in the XML formatted output data returned by the QL Web Service, in accordance with one embodiment of the present invention;

FIG. 9 shows a table that lists the XML formatted sub-elements of the diagnostics element, in accordance with one embodiment of the present invention;

FIG. 10 shows an example listing of XML formatted data and corresponding JSON formatted data, where the JSON formatted data has been transformed from the XML formatted data according to the rules listed above, in accordance with one embodiment of the present invention;

FIG. 11A shows a listing of attributes available for specification in association with the table element, in accordance with one embodiment of the present invention;

FIG. 11B shows a table that lists whether access is available depending on the value in the securityLevel attribute;

FIG. 12 shows a listing of attributes available for specification in association with the meta sub-element, in accordance with one embodiment of the present invention;

FIG. 13 shows a listing of attributes available for specification in association with the bindings/select element, in accordance with one embodiment of the present invention;

FIG. 14 shows a table indicating which keywords (select, insert, update, delete) support the key, value, and map elements, in accordance with one embodiment of the present invention;

FIG. 15 shows a table listing the attributes available within the key, value, and map elements, in accordance with one embodiment of the present invention;

FIG. 16 shows a table listing the attributes available within the pagesize, start, total, and nextpage elements, in accordance with one embodiment of the present invention;

FIG. 17 shows an example QL Open Data Table defined to tie into the Flickr API and allow the QL Web Service to retrieve data from a Flickr photo search, in accordance with one embodiment of the present invention;

FIG. 18 shows an example QL Open Data Table defined to the Gnip API to retrieve activities from a Publisher, which in this example is Digg, in accordance with one embodiment of the present invention;

FIG. 19 shows an architectural view of the QL Web Service system, in accordance with one embodiment of the present invention; and

FIG. 20 shows a system level view of the QL Web Service, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

A Query Language (QL) Web Service is disclosed herein that enables developers and their applications to query, filter, and combine data from different sources across the Internet. In one embodiment, the QL Web Service is referred to as the Yahoo! Query Language (YQL) Web Service. However, in other embodiments, the QL Web Service can be referred to by other names. It should be understood that the QL Web Service is a web service that is accessible through the Internet via a URL, and that can be interfaced with using a well-defined language to effect acquisition and consumption of data from one or more web services and/or web data sources.

The QL Web Service operates within a system that includes: 1) the QL Web Service, 2) one or more back-end web data sources/services, and 3) one or more QL tables respectively associated with the one or more back-end web data sources/services. The back-end web data sources/services represent entities that exist in the Internet realm that contain data of interest of various types and that are accessible through the Internet via a URL. For ease of discussion, the back-end web data sources/services are referred to hereafter as web data sources. It should be understood, however, that the term web data source as used herein refers to either data or a service that is accessible through the Internet via a URL.

The QL table is a file which includes information that can be read and understood by the QL Web Service to inform the QL Web Service on how to access and interact with a particular web data source for which the QL table is defined. The QL table serves as a mediator and interpreter between the QL Web Service and the particular web data source for which the QL table is defined. It should be understood that the QL Web Service relies upon the QL table to provide information regarding how to access a web data source, what data is available at the web data source and the data format(s), how to get data from the web data source, and how to manipulate data at the web data source. Therefore, the QL Web Service itself is not hard-coded with knowledge about any particular web data source, but rather the QL Web Service is defined to obtain and understand information from a mediating QL table with regard to interfacing and interacting with a particular web data source. Also, it should be understood that the data that is obtained by the QL Web Service is actually obtained from the back-end web data source, and the QL table provides the binding between the QL Web Service and back-end data source that enables that data to be obtained.

Each QL table for a given web data source is defined in a format that is understood by the QL Web Service. In one embodiment, QL tables are defined in an XML format. However, it should be understood that in other embodiments, the QL tables can be defined in different formats, so long as the QL Web Service is capable of understanding the information contained within the QL tables. The web data sources that are accessed by the QL Web Service can be defined in essentially any format. The binding provided by the QL table between the QL Web Service and a particular web data source informs the QL Web Service as to what type(s) of data are present within the particular web data source. Using the binding information gleaned from the QL table, the QL Web Service knows how to access the data present at the particular web data source in its native format. Once the QL Web Service accesses and retrieves the data from the web data source in its native format, the QL Web Service converts the retrieved data into an internal format for processing within the QL Web Service. In one embodiment, the internal format is an XML format. However, it should be understood that is other embodiments, the QL Web Service can be defined to use any one of a number of different internal formats.

Based on user-specified controls and parameters, the QL Web Service is defined to generate a set of results data from the various data that is retrieved from the one or more back-end web data sources. The QL Web Service is defined to convey the set of results data in either of multiple output formats as specified by the user of the QL Web Service. Specifically, the QL Web Service is defined to convert the set of results data from the internal format used by the QL Web Service into a user-specified output format. In one embodiment, the user-specified output format is either an XML format or a JSON format. However, it should be understood that in other embodiments the QL Web Service can be defined to convey the set of results data in essentially any known output format, as selected by the user of the QL Web Service.

Before delving into the more detailed description of the QL Web Service and the language (QL) it exposes for its use, a few features of QL Web Service's utility should be understood and appreciated. It should be understood and appreciated that a user of the QL Web Service does not need to know either the URLs of any web data source to be accessed or the complexities associated with calling the URLs of any web data source. Each QL table that is associated with a particular web data source provides the knowledge to the QL Web Service regarding the URLs of the particular web data source and the complexities associated with calling the URLs of the particular web data source. The QL Web Service in turn abstracts this detailed and complex information regarding the particular web data sources URLs to the user of the QL Web Service. More specifically, the QL exposed by the QL Web Service allows the user to specify in a single statement one or more QL tables to be operated upon, one or more parameters to be operated upon within the specified QL table(s), and one or more operations to be performed on the specified parameter(s). It should be appreciated that the user does not need to know anything about the URLs that are associated with the web data sources represented by the one or more QL tables. This feature will become more apparent in the description to follow.

Additionally, a feature of the QL Web Service to be appreciated throughout the description herein is that the QL Web Service provides for joining of data from different web data sources, regardless of ownership of the different web data sources, and regardless of how the different web data sources are provisioned and made accessible through the Internet. The web data sources that can be accessed by the QL Web Service, by way of appropriately defined QL tables, can be owned by any entity, can be located anywhere in the world, and can include data of any type. Thus, the QL Web Service provides for joining web data sources together, regardless of their diversity in ownership, location, and/or format, to produce a combined set of results data. Although the above-mentioned features of the QL Web Service are quite substantial, it should be understood that the QL Web Service provides many additional features and services, as will be apparent from the following more detailed description of the QL Web Service and its associated query language.

The QL Web Service query language (QL) includes a number of different statements that can be submitted through an appropriately formatted URL to the QL Web Service to access one or more data sources on the Internet, acquire data from the data source, transform the acquired data, and output the set of results data in a selected format, such as XML or JSON format. The QL Web Service can access essentially any type of data source, including but not limited to Yahoo! Web Services, other web services, and web content in formats such as HTML, XML, JSON, RSS, Atom, and microformat, among others.

The QL Web Service is accessed through a URL which is defined to include a QL statement for acquiring and/or manipulating data at one or more web data sources. In one embodiment, the QL Web Service has two URLs, wherein one URL allows access to public data and the other URL allows access to both public and private data. For example, in one embodiment, the following URL allows access to public data, which does not require authorization:
http://query.yahooapis.com/v1/public/yql?[query_params]

Also by way of example, the following URL requires authorization, e.g., by OAuth, and allows access to both public and private data:
http://query.yahooapis.com/v1/yql?[query_params]

It should be understood that the provider of data at a web data source may implement some type of protection on the data such that authorization of some sort is required to access the data. If a web data source is protected, the QL table associated with the web data source is defined to specify the type of protection implemented and the requirements for accessing the web data source. For example, when the web data source requires OAuth credentials, the associated QL table will specify that OAuth credential are required. Then, the user of the QL Web Service, having seen the QL table description, will know that appropriate OAuth credentials must be provided to access the web data source.

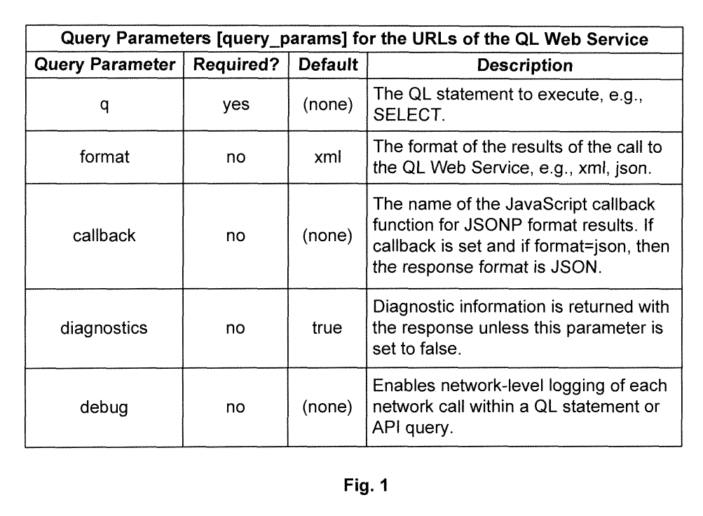

FIG. 1 shows a table of query parameters [query_params] for the URLs of the QL Web Service, in accordance with one embodiment of the present invention. It should be understood that the QL Web Service is not limited to the query parameters shown in FIG. 1. Other embodiments of the QL Web Service may include additional query parameters that are not shown in FIG. 1.

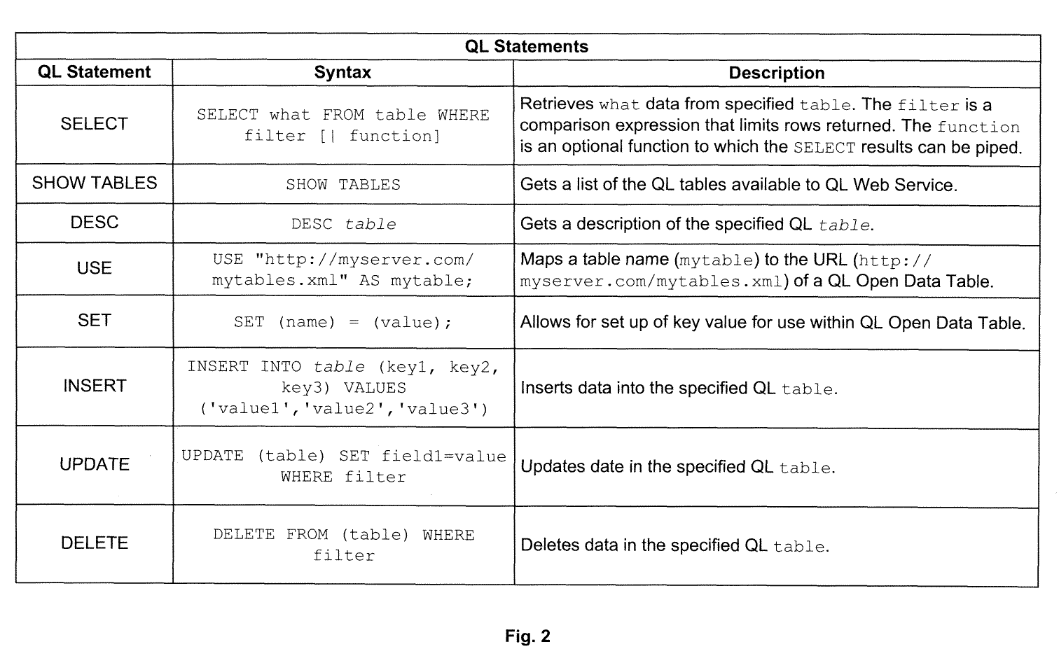

FIG. 2 shows a table of QL statements that can be submitted to the QL Web Service via the query parameter [q=] in the URL of the QL Web Service, in accordance with one embodiment of the present invention. It should be understood that the QL statements are not limited those shown in FIG. 2. Other embodiments of the QL Web Service may provide for use of additional QL statements that are not shown in FIG. 2.

As indicated in FIG. 2, the QL statements operate on QL tables. As discussed above, the QL table is a file which includes information that can be read and understood by the QL Web Service to inform the QL Web Service on how to access and interact with a particular web data source. The web data source for which the QL table is defined often contains very large collections of structured data. The Yahoo! QL Web Service includes an extensive list of built-in QL tables that cover a wide range of Yahoo! Web Services and access to off-network data. Additionally, the QL Web Service provides for creation and use of QL Open Data Tables to bind any web data source to the QL Web Service, thereby enabling access to and consumption of the web data source through the QL Web Service.

As mentioned above, some web data sources may implement access protection. A QL table associated with a protected web data source that requires access authorization in some form is referred to as a private QL table. A QL table associated with a non-protected web data source that does not require access authorization is referred to as a public QL table. An application can access a public QL table through an endpoint that does not require authentication. For example, in one embodiment, an application can access a public QL table through the /v1/public/yql endpoint of the Yahoo! QL Web Service, which does not require authorization. In another example, an application can access a private QL table through the /v1/yql endpoint of the Yahoo! QL Web Service by supplying appropriate credentials, such as OAuth credentials. OAuth is an open standard that allows Yahoo! users to share their private resources stored on Yahoo! with developers without having to hand out their username and password.

The Yahoo! QL Web Service supports two-legged and three-legged OAuth. The two-legged OAuth is an OAuth authorization between two parties: (1) an application (the Consumer) and (2) the public data source (the Service Provider). The public data source can be a Web service or Web feeds such as RSS or Atom feeds. A public data source does not require authorization from the end user of the application. The three-legged OAuth is an OAuth authorization between three parties: (1) the end user (User), (2) the application (the Consumer), and (3) the private data source (the Service Provider). An application that uses the Yahoo! Social Directory APIs for example, need authorization by the end user to access private social data.

It should be understood that a QL table referenced herein may be either a private QL table or a public QL table depending on the web data source with which it is associated. However, regardless of the whether the QL table is public or private, the QL Web Service is defined to utilize the QL table in the same manner such that the QL table serves as a mediator between the QL Web Service and the associated web data source.

The QL statements of FIG. 2 can be run in several ways. In one embodiment, the QL statements can be run in a Yahoo! QL Console, which is a QL Web Service user interface that is executable within a web browser. The Yahoo! QL Console is described in related U.S. patent application Ser. No. ______ (Attorney Docket No. YAHOP096/Y05810US00), filed on even date herewith, entitled “Developer Interface and Associated Methods for System for Querying and Consuming Web-Based Data,” which is incorporated herein by reference in its entirety.

In another embodiment, a web application can use an HTTP request, such as an HTTP GET request for example, when running SELECT statements, wherein the QL statement is specified as a query parameter of the QL Web Service URL. In one embodiment, a web application can use an HTTP GET, PUT, or DELETE request for the QL statements INSERT, UPDATE, and DELETE, respectively. One exception is when a JSONP callback is specified in the QL statement. In an example embodiment of this case, an HTTP GET request can be used with a callback query parameter specified on the GET URI. In yet another embodiment, a web application that uses the PHP SDK can call a query method of the YahooSession class.

### QL Statement: SELECT

The SELECT statement of QL retrieves data from one or more QL tables which reference respective web data sources. The QL Web Service fetches data from a back-end web data source, transforms the data as directed, and outputs the data in a specified format. In one embodiment, the specified output format is either XML or JSON format. In this embodiment, output data is presented in a tabular arrangement in which table rows are represented as repeating XML elements or JSON objects, and table columns are XML sub-elements or attributes, or JSON name-value pairs. It should be understood, however, that in other embodiments the QL Web Service can be defined to output results in essentially any format.

The QL SELECT statement has the following syntax:
SELECT what FROM table WHERE filter [|function]

The what clause contains the data fields to retrieve. The data fields correspond to the XML elements or JSON objects that will be conveyed in the output data returned by the QL Web Service based on execution of the SELECT statement. Therefore, the data fields in the what clause represent the columns in the tabular arrangement of output results returned by the QL Web Service. An asterisk (*) in the what clause means all data fields. The table parameter is a QL table (either a QL pre-defined, i.e., built-in, table or a QL Open Data Table) that binds a web data source to the QL Web Service. The filter parameter is a comparison expression that limits the data rows in the output data returned by the SELECT statement. The output data results of the SELECT statement can be piped, via the pipe symbol (“|”), to an optional function, such as a sort function. In one embodiment of QL, statement keywords such as SELECT and WHERE are case-insensitive. However, table and field names are case sensitive. In string comparisons, the values are case sensitive. String literals are enclosed in quotes. Either double or single quotes are allowed.

The QL Web Service includes a projection feature by which a vertical slice, i.e., projection, of the web source data referenced in the associated QL table can be queried. Specifically, data fields can be specified by name in the what clause following the SELECT keyword. Multiple data fields can be delimited by commas. For example,
SELECT lastUpdated, itemurl FROM social.updates WHERE guid=me
   will return data from the web data source corresponding to the data fields lastUpdated and itemurl from the row in QL table social.updates that has guid=me.

All data fields can be specified by an asterisk (*). For example,
SELECT*FROM social.updates WHERE guid=me
   will return data from the web data source corresponding to all the data fields in QL table social.updates that has guid=me

If the data fields in the result set contain data sub-fields, the data sub-fields can be specified by using periods (dots) as delimiters. This format is referred to as “dot-style syntax.” For example, for the social.profile QL table, to get only the imageUrl data sub-field of the image data field, the following can be specified:
SELECT image.imageUrl FROM social.profile WHERE guid=me

The following lines show part of the output results returned by the QL Web Service (in XML format) for this SELECT statement. Note that only the imageUrl data subfield is returned.

<results>
<profile
xmlns=“http://social.yahooapis.com/v1/schema.rng”>
<image>
<imageUrl>http://l.yimg.com/us.yimg.com/i/identity/nopi
c_192.gif</imageUrl>
</image>
</profile>
</results>

If one or more non-existent data fields is specified in the what clause, an HTTP response code is returned, such as 200 OK. If none of the data fields in the what clause exist, the result set is empty. That is, zero rows are returned.

The filter in the WHERE clause determines which rows are returned by the SELECT statement. In other words, the filter represents the rows in the tabular arrangement of output results returned by the QL Web Service. The filter in the following statement, for example, returns rows only if the text field matches the string Barcelona:
SELECT*FROM flickr.photos.search WHERE text=‘Barcelona’

In one embodiment, the QL has two types of filters: remote and local. These filter types are differentiated by where the filtering takes place relative to the QL Web Service. With a remote filter, the filtering takes place at the back-end web data source called by the QL Web Service. A remote filter has the following syntax:
input_key=literal

The input key is a parameter that QL passes to the back-end web data source. The literal is a value (either a string, integer, or float). Only the equality (=) operator is allowed in a remote filter. For example, in the following statement, the input key is photo_id:
SELECT*FROM flickr.photos.info WHERE photo_id=‘2186714153’

For this SELECT statement, the QL Web Service calls the Flickr Web Service, passing photo_id as follows:
http://api.flickr.com/services/rest/?method=flickr.photos.getInfo&photo_id=‘2186714153’

Most QL tables require the SELECT statement to specify a remote filter, which requires an input key. Often, the input key is not one of the data fields included in the output results returned by a SELECT statement. To see which input keys are allowed or required, the DESC statement can be run for the QL table, and the key element of the results can be noted. For example, as shown in the following lines, the results of DESC flickr.photos.info show that the input key photo_id is required:

<results>
. . .
<select>
<key name=“secret” type=“xs:string”/>
<key name=“photo_id” required=“true” type=“xs:string”/>
</select>
. . .
<results>

Multiple remote filters can be combined with the boolean AND or OR operators. For example:
SELECT*FROM flickr.photos.info WHERE photo_id=‘2186714153’ or photo_id=‘3502889956’

The SELECT statements for some QL tables may include multiple remote filters. For example:
SELECT*FROM local.search WHERE zip=‘94085’ and query=‘pizza’

The QL Web Service also performs local filtering on the data it retrieves from the back-end web data source. A local filter has the following syntax:
field comparison_operator literal

The field parameter specifies the name of a data field in the output of the QL Web Service, e.g., the field parameter corresponds to an XML element or a JSON object in the output data to be conveyed by the QL Web Service. To specify a data sub-field, the containing data fields are separated with periods. For example, the data sub-field AverageRating is specified as Rating.AverageRating where the data field Rating includes the data sub-field AverageRating. The literal parameter is either a quoted string, an integer, or a float.

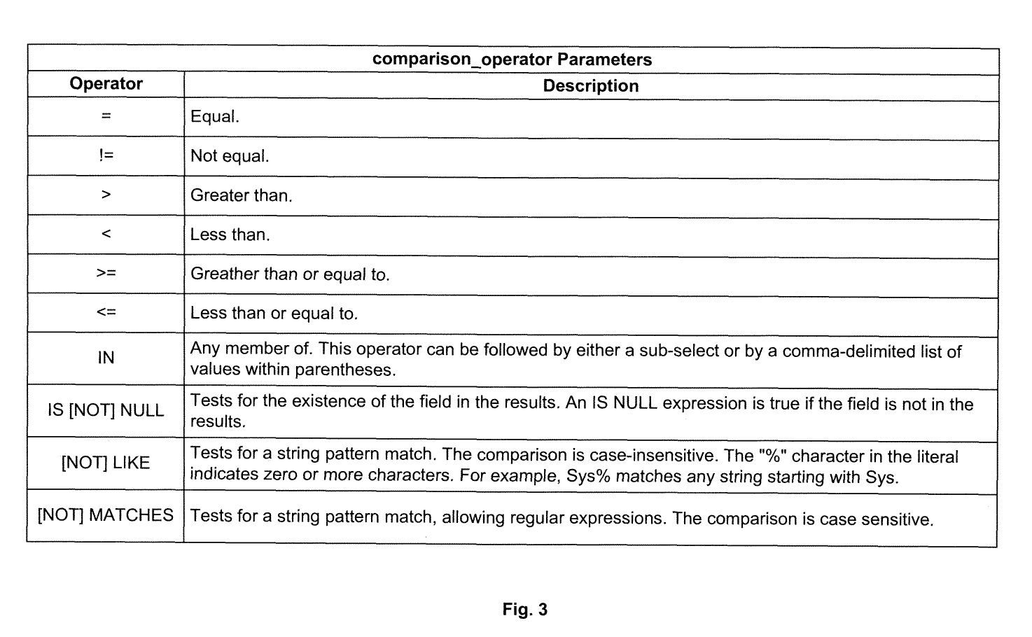

FIG. 3 shows a table of possible comparison_operator parameters that can be specified between the field and literal parameters, in accordance with one embodiment of the present invention. It should be understood that the QL Web Service is not limited to the comparison_operator parameters shown in FIG. 3. Other embodiments of the QL Web Service may include additional comparison_operator parameters that are not shown in FIG. 3.

In the following example QL statement, the QL Web Service is directed to get data from the flickr.photos.interestingness QL table, then apply the local filter title=‘moon’:
select*from flickr.photos.interestingness where title=‘moon’

In the following example QL statement, the local filter checks that the value of the title field starts with the string Chinese or CHINESE:
select*from flickr.photos.interestingness where title like ‘Chinese %’

In the following example QL statement, the local filter contains a regular expression that checks for the substring blue:
select*from flickr.photos.interestingness where title matches ‘.*blue.*’

In the following example QL statement, the local filter is specified to return recent photos with the IDs specified in the parentheses:
select*from flickr.photos.recent where id in (‘3630791520’, ‘3630791510’, ‘3630791496’)

Local and remote filter expressions can be combined with the boolean AND and OR operators. In one embodiment, the AND operator has precedence over the OR operator. To change precedence, expressions can be enclosed in parentheses. An example QL statement that combines filters is as follows:
select*from local.search where query=“sushi” and location=“san francisco, ca” and Rating.AverageRating=“4.5”

In the above example, the first two filters are remote expressions because query and location are input keys. The third filter in the above example that contains the data field Rating.AverageRating, is a local filter.

Based on the foregoing, it should be understood that a remote filter is represented by a key word in an equality expression. The remote filter name, i.e., key word, is defined in the QL table and may or may not directly correspond to some term known by the back-end data source associated with the QL table. However, the QL table defines what remote filters can be provided, what the key words are for those remote filters, and how the remote filters are applied to the URL that gets created to call the back-end data source. The remote filter is passed to the back-end data source and is applied at the back-end data source. The local filter is represented by a data field in a comparison expression. The data field is a field name defined in the QL table. The data field is not known by the back-end data source. The data field is used by the QL Web Service to identify data during operation on the data within the QL Web Service and within the output data results conveyed by the QL Web Service.

It is possible to join data from different web data sources by specifying their respective QL tables using a sub-select form of the QL statement. As previously mentioned, the QL Web Service provides for joining of data from different web data sources, regardless of ownership of the different web data sources, and regardless of how the different web data sources are provisioned and made accessible through the Internet. The web data sources that can be accessed by the QL Web Service, by way of appropriately defined QL tables as specified in a sub-select form of the QL statement, can be owned by any entity, can be located anywhere in the world, and can include data of any type. Thus, the sub-select feature of the QL Web Service provides for joining web data sources together, regardless of their diversity in ownership, location, and/or format, to produce a combined set of results data.

The sub-select provides input for the IN operator of the outer SELECT statement. The values in the outer SELECT statement can be either input keys known the back-end web data source (remote filters) or data fields known to the QL Web Service by way of their definition in the QL table (local filters). For example, by using a sub-select, the following QL statement returns the profiles of all of the connections (friends) of the user currently logged in to Yahoo!:
select*from social.profile where guid in (select guid from social.connections where owner_guid=me)

In the example above, the QL statement joins the social.profile and social.connection QL tables on the values of the GUIDs. More specifically, the inner SELECT, which follows the word IN, returns the GUIDs for the user's connections. For each of these GUIDs, the outer SELECT returns the profile information.

QL tables can also be joined on multiple keys. In the following example, the local.search and geo.places tables are joined on two keys:
select*from local.search where (latitude,longitude) in (select centroid.latitude, centroid.longitude from geo.places where text=“north beach, san francisco”) and radius=1 and query=“pizza” and location=””

In the above example, the inner SELECT returns two data fields (centroid.latitude and centroid.longitude) which are compared with the two input keys (latitude and longitude) of the outer SELECT.

The next example shows an inner SELECT that returns data from an RSS feed:
select*from search.web where query in (select title from rss where url=“http://rss.news.yahoo.com/rss/topstories”|truncate(count=1))

In one embodiment, one sub-select is allowed in each SELECT. In other words, each SELECT statement can only have one IN keyword, but the inner SELECT may also have an IN keyword. The following statement is acceptable:
select*from search.siteexplorer.pages where query in (select url from search.web where query in (select Artist.name from music.release.popular limit 1) limit 1)

However, the following statement is not acceptable because it has two IN keywords in a SELECT:
select*from flickr.photos.search where lat in (select centroid.latitude from geo.places where text=“sfo”) and lon in (select centroid.longitude from geo.places where text=“sfo”)

Many QL Web Service queries access back-end web data sources that contain thousands, or even millions, of items. When querying large web data sources, applications may need to page through the results data to improve performance and usability. The QL Web Service enables applications to implement paging or to limit output data table size at either a remote level or at a local level. To find out how many items (output data rows) a query (SELECT) returns in XML formatted output data results, the value of the yahoo:count attribute of the query element can be checked in the output data results. Similarly, to find out how many items (output data rows) a query (SELECT) returns in JSON formatted output data results, the value of the count object can be checked in the output data results. In one embodiment, the maximum number of items returned by a SELECT is 5000. Also, in one embodiment, the maximum processing time for a QL statement is 30 seconds. Also, in one embodiment, for most QL tables, the default number of items returned is 10, if a limit is not specified in the SELECT statement. It should be understood, however, that in other embodiments the maximum number of items returned by a SELECT statement, the maximum processing time for a QL statement, and the default number of items returned can be set at values different than those stated for the example embodiments above.

A remote limit controls the number of items (rows) that the QL Web Service retrieves from the back-end web data source. To specify a remote limit, an offset (start position) and a number of items is specified in parentheses after the table name. The default offset is 0. For example, in the following QL statement, the offset is 0 and the number of items is 10:
select title from search.web(0,10) where query=“pizza”

When QL statement above runs, QL calls Yahoo! Search BOSS (the back-end web data source for the search.web QL table) and gets the first 10 items that match the query=“pizza” filter.

The following example QL statement gets items 10 through 40, i.e., starting at position 10, it gets 30 items:
select title from search.web(10,30) where query=“pizza”

If only one number (n) is provided in the remote limit controls, the offset is considered to be 0, and the number of items is considered to be (n). Therefore, the remote limit control of (n) is the same as the remote limit control of (0,n). For example, the following QL statement gets the first 20 items because the default offset is 0:
select title from search.web(20) where query=“pizza”

The default number of items for a remote limit varies with the QL table. For most QL tables, the default number of items is 10. The maximum number of items also varies with the QL table. To get the maximum number of items, enter 0 in parentheses after the table name. For example, the following QL statement returns 1000 items from the back-end web data source associated with the search.web QL table:
select title from search.web(0) where query=“pizza”

A local limit controls the number of output data rows the QL Web Service returns to the calling application. The QL Web Service applies a local limit to the data set that it has already retrieved from the back-end web data source. To specify a local limit, the LIMIT and OFFSET keywords (each followed by an integer) can be included after the WHERE clause. The integer value following the LIMIT keyword specifies the number of rows. The integer value following the OFFSET keyword indicates the starting position. The OFFSET keyword is optional. The default offset is 0, which is the first row.

The following example QL statement has a remote limit of 100 and a local limit of 15:
select title from search.web(100) where query=“pizza” limit 15 offset 0

When the above QL statement runs, the QL Web Service gets up to 100 items from the back-end web data source. On these items, the QL Web Service applies the local limit and offset. So, the above QL statement returns 15 output data rows to the calling application, starting with the first row (offset 0).

The QL Web Service retrieves items from the back-end web data source one page at a time until either the local or remote limit has been reached. The page size to be applied to the back-end web data source is specified in the associated QL table and can vary between QL tables. The following example QL statement has an unbounded remote limit (0), so the QL Web Service retrieves items from the back-end web data source until the local limit of 65 is reached:
select title from search.web(0) where query=“pizza” limit 65

The QL Web Service includes built-in functions such as sort, which are appended to the SELECT statement with the pipe symbol (“|”). These functions are applied to the result data set after all other operations specified in the SELECT statement have been performed, such as applying filters and limits. The following is an example QL statement that includes an appended function:
select*from social.profile where guid in (select guid from social.connections where owner_guid=me)|sort(field=“nickname”)

In the above QL statement, the sub-select returns a list of GUIDs, and the outer select returns a set of profiles, one for each GUID. This set of profiles is piped to the sort function, which orders the results according to the value of the nickname field.

Multiple functions can be chained together with the pipe symbol (“|”). The following QL statement queries the local.search table for restaurants serving pizza. The results are piped to the sort function, then to the reverse function. The final result contains up to 20 rows, sorted by rating from high to low:
select Title, Rating.AverageRating from local.search(20) where query=“pizza” and city=“New York” and state=“NY”|sort(field=“Rating.AverageRating”)|reverse( )

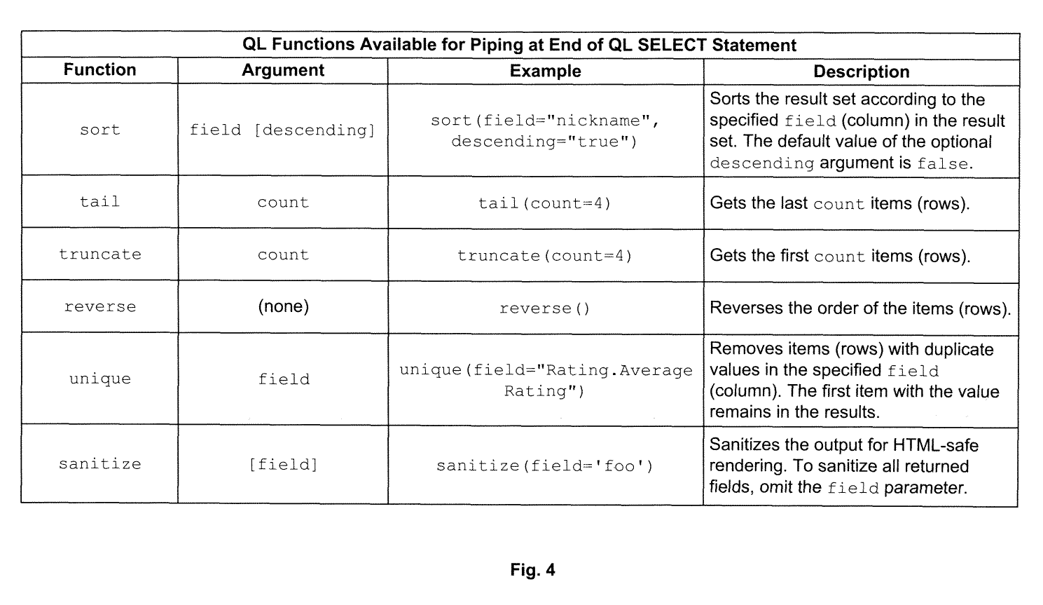

FIG. 4 shows a table of possible QL functions that can be appended to a QL SELECT statement, in accordance with one embodiment of the present invention. Function arguments are specified in FIG. 4 as name-value pairs. It should be understood that the QL Web Service is not limited to the QL functions shown in FIG. 4. Other embodiments of the QL Web Service may include additional QL functions that are not shown in FIG. 4.

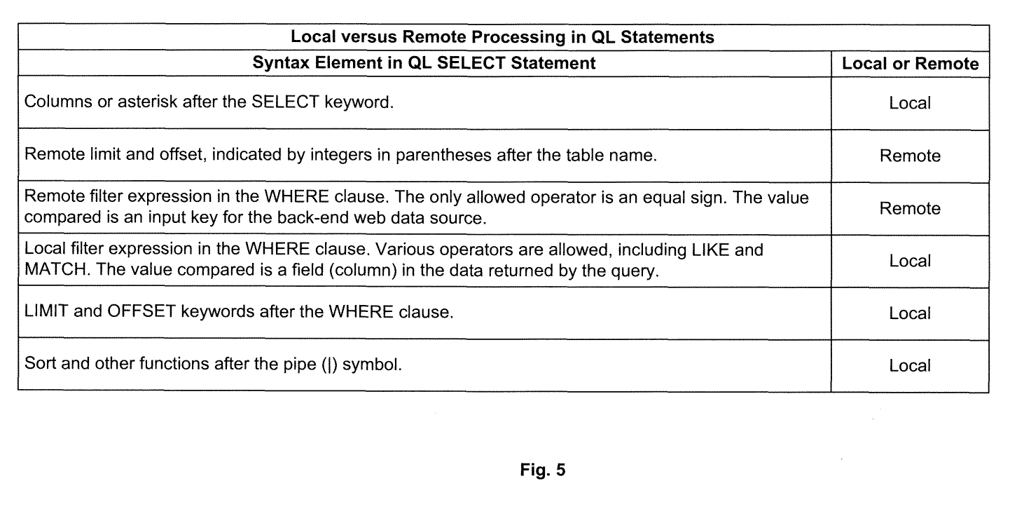

When QL runs a SELECT statement, it accesses a back-end web data source, typically by calling a web service. Remote filters and limits are implemented by the back-end web service. Local processing, including local filters and limits, is performed by the QL Web Service on the data it fetches from the back-end web data source. It should be appreciated that whether an operation is remote or local affects the data returned to the application that calls the SELECT statement. FIG. 5 shows a table which identifies whether an element in a QL SELECT statement is processed locally or remotely, in accordance with one embodiment of the present invention.

In one embodiment, the QL Web Service includes a set of pre-defined, i.e., built-in, QL tables that call the Yahoo! Social APIs. The social.profile table, for example, contains information about a Yahoo! user, and the social.connections table is a list of the user's friends. The Global User Identifier (GUID) is a string that uniquely identifies a Yahoo! user. In this embodiment of the QL Web Service, the me keyword is the GUID value of the user currently logged in to Yahoo!. For example, if a given person is logged in to Yahoo!, and that given person runs the following statement, the QL Web Service will return the given person's profile information:
select*from social.profile where guid=me

Because me is a keyword, it is not enclosed in quotes. To specify a GUID value, the GUID value can be expressed as a string enclosed in quotes, such as in the following example:
select*from social.updates where guid=‘7WQ7JILMQKTSTTURDDAF3NT35A’

If a URL for a call to the QL Web Service contains @var literals, the QL Web Service replaces the literals with the values of query parameters with the same names. For example, suppose that the URL for the call to the QL Web Service has the animal query parameter:
http://query.yahooapis.com/v1/yql?animal=dog&q=select*from sometable where animal=@animal

For the above example URL, the QL Web Service will run the following SELECT statement:
select*from sometable where animal=“dog”

The QL Web Service includes the ability to access data at back-end web data sources that are formatted as structured data feeds such as RSS and ATOM. However, if no such feed is available, it is possible to specify the source as HTML and use XPath to extract the relevant portions of the HTML page. For example, to get information from Yahoo! Finance about Yahoo! Inc. stock (YHOO), the following QL statement may be initially used:
select*from html where url=“http://finance.yahoo.com/q?s=yhoo”

Because the above QL statement returns all of the page's HTML, it would not be very useful in an application. By adding an XPath expression to the above QL statement, it is possible retrieve specific portions of the HTML page. The XPath expression in the following statement traverses through the nodes in the HTML page to isolate the latest headlines:
select*from html where url=“http://finance.yahoo.com/q?s=yhoo” and xpath=‘//div[@id=“yfi_headlines”]/div[2]/ul/li/a’

In the above example, the)(Path expression looks first for a div tag with the ID yfi_headlines. Next, the expression gets the second div tag and looks for an anchor tag (a) within a list item (li) of an unordered list (ul). The following QL statement also gets information about Yahoo! Inc. stock, but traverses the nodes to get key statistics:
select*from html where url=“http://finance.yahoo.com/q?s=yhoo” and xpath=‘//div[@id=“yfi_key_stats”]/div[2]/table’

Instead of the wildcard asterisk (*) as shown above, it is possible to specify a particular element for the XPath to process. For example, the following statement extracts only the HTML links (href tags) within the headlines on Yahoo! Finance:
select href from html where url=“http://finance.yahoo.com/q?s=yhoo” and xpath=‘//div[@id=“yfi_headlines”]/div[2]/ul/li/a’

To get just the content from an HTML page, it is possible to specify the content keyword after the word select. A QL statement with the content keyword processes the HTML in the following order:

1. The QL statement looks for any element named “content” within the elements found by the XPath expression.

2. If an element named “content” is not found, the QL statement looks for an attribute named “content”.

3. If neither an element nor attribute named “content” is found, the QL statement returns the element's textContent.

The following QL statement, for example, returns the textContent of each anchor (a) tag retrieved by the XPath expression:
select content from html where url=“http://finance.yahoo.com/q?s=yhoo” and xpath=‘//div[@id=“yfi_headlines”]/div[2]/ul/li/a’

### QL Statement Output Data

In one embodiment, the QL Web Service can return, i.e., output, data in either XML, JSON, or JSONP format. However, it should be understood that in other embodiments the QL Web Service can be extended to return data in essentially any format. In one embodiment, the default format is XML. In this embodiment, to get output data in

JSON format, include the format=j son parameter in the URL of the QL Web service. For example:
http://query.yahooapis.com/v1/public/yql?q=select*from social.connections where owner_guid=me&format=json

To specify JSONP as the output data format, include both the format and callback query parameters in the URL of the QL Web service. The callback parameter indicates the name of the JavaScript callback function. For example:
http://query.yahooapis.com/v1/public/yql?q=select*from social.connections where owner_guid=me&format=json&callback=cbfunc

It should be understood that the format of the output data conveyed by the QL Web Service is not dependent on the data format at the back-end web data source. For example, if a back-end web data source expresses its data in XML format, the QL Web Service is not restricted to conveying the data acquired therefrom in XML format. For example, in this case the QL Web Service can return output data in JSON format or any other format.

In one embodiment, the QL Web Service also provides for returning output data as a JSON envelope having XML content. More specifically, if the QL statement specifies a callback (callback=cbfunction) and also requests the format to be in XML (format=xml), then the QL Web Service returns a string representation of the XML within an array. This type of output data format is referred to as JSONP-X.

In one embodiment, each response from the QL Web Service includes a query element, which contains diagnostics and results elements. Repeating elements within results element correspond to “rows” from a QL table. For example, the following QL statement returns multiple connection elements within the results element:
select*from social.connections

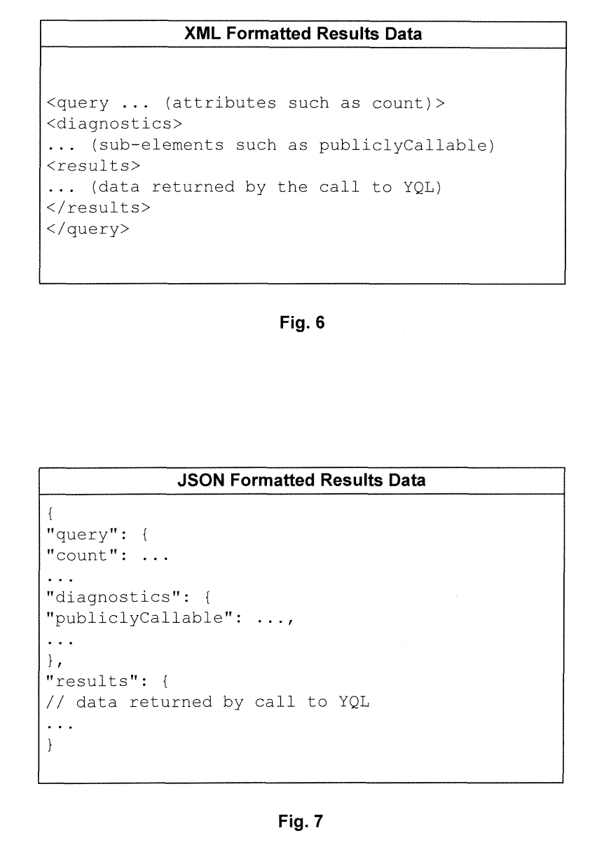

FIG. 6 shows the basic structure of the XML formatted output data in the response generated by a call to the QL Web Service, in accordance with one embodiment of the present invention. FIG. 7 shows the basic structure of the JSON formatted output data in the response generated by a call to the QL Web Service, in accordance with one embodiment of the present invention.

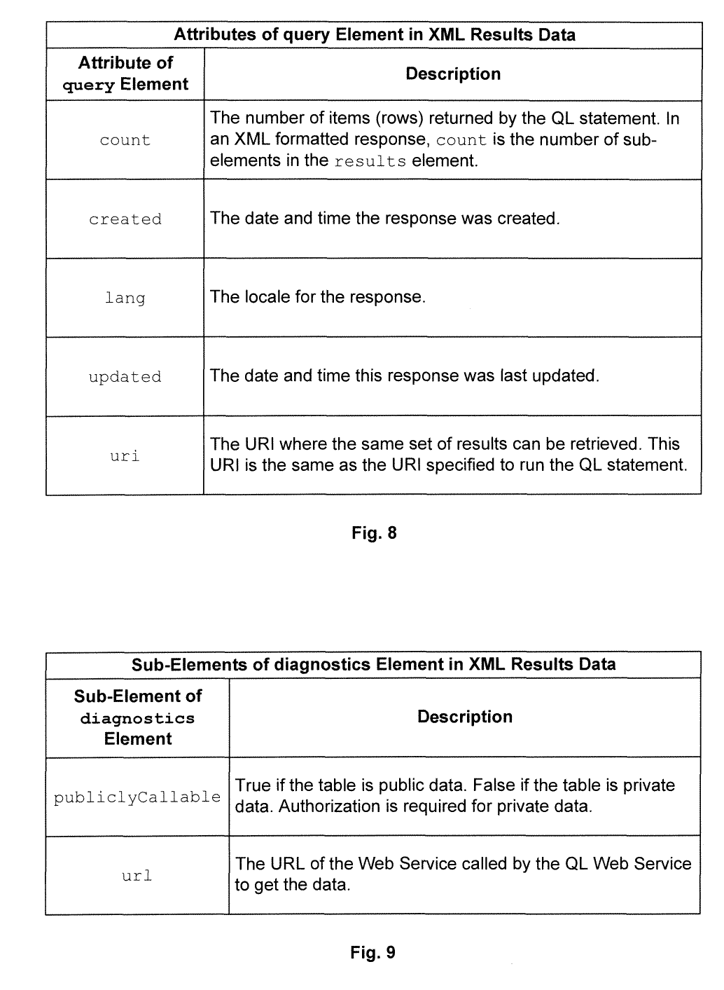

The attributes of the query element and the sub-elements of the diagnostics element in the output data generated by execution of a given QL statement can be examined to get information about the execution of the given QL statement. FIG. 8 shows a table that lists the attributes of the query element in the XML formatted output data returned by the QL Web Service, in accordance with one embodiment of the present invention. In the JSON formatted response data, the attributes listed in FIG. 8 are mapped to the name-value pairs contained in the query object.

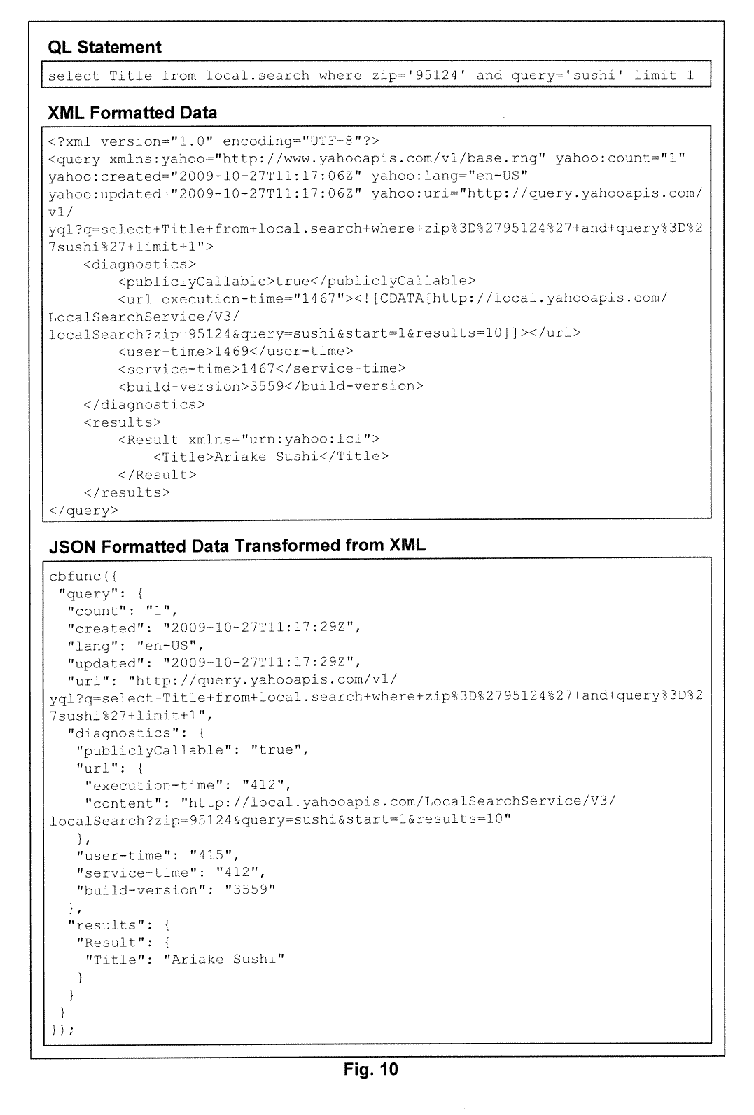

The diagnostics element in the output data includes information about the calls the QL Web Service made to the back-end web data sources. FIG. 9 shows a table that lists the XML formatted sub-elements of the diagnostics element, in accordance with one embodiment of the present invention. In the JSON formatted output data, the sub-elements listed in FIG. 9 are mapped to name-value pairs contained in the diagnostics object.

If the QL Web Service output data is returned in JSON format, and the back-end web data source is defined in an XML format, then the QL Web Service transforms the data from XML format to JSON format. In one embodiment, the QL Web Service transforms XML formatted data to JSON formatted data according to the following rules:
Attributes are mapped to name:value pairs.
Element CDATA or text sections are mapped to “content”:value pairs if the element contains attributes or sub-elements. Otherwise, they are mapped to the element name's value directly.
Namespace prefixes are removed from names.
If the attribute, element, or namespace-less element would result in the same key name in the JSON structure, an array is created instead.

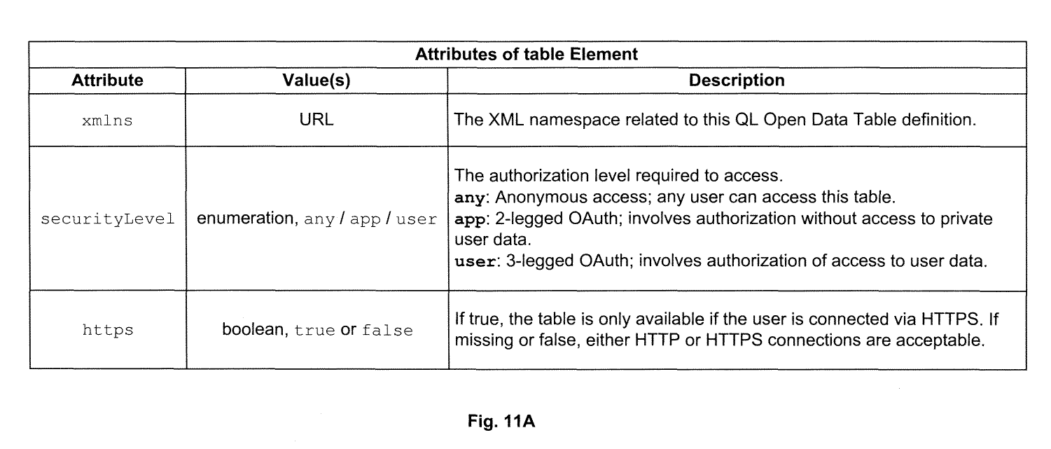

FIG. 10 shows an example listing of XML formatted output data and corresponding JSON formatted output data, where the JSON formatted output data has been transformed from the XML formatted data according to the rules listed above, in accordance with one embodiment of the present invention. It should be understood that transformation from XML format to JSON format can be “lossy,” in that the data may not be transformable back into the XML format from the JSON format.

In one embodiment, the QL Web Service is defined to return the following HTTP response codes:
200 OK: The QL statement executed successfully. If the QL statement is syntactically correct and if authorization succeeds, it returns 200 OK even if the calls to back-end data services fail, i.e., return other error codes.
400 Bad Request: Malformed syntax or bad query in QL statement. This error occurs if the WHERE clause does not include a required input key. In the returned results data, the XML error element includes a text description of the error.
401 Authorization Required: The user running the application calling the QL Web Service is not authorized to access the private data indicated in the QL statement.

### QL Tables

The QL Web Service includes an extensive list of built-in QL tables for use that cover a wide range of Yahoo! Web services and access to off-network data. A listing of the built-in QL tables can be obtained by running the QL statement SHOW TABLES. A description of any QL table can be obtained by running the QL statement DESC table, where table is the name or URL of the QL table to be described.

Additionally, the QL Web Service provides for creation and use of QL Open Data Tables, thereby enabling the QL Web Service to bind with any web data source through the QL language. A QL Open Data Table definition is an independently defined structured file, e.g., XML file, that contains at least the following information to enable binding of the associated web data source with the QL Web Service:
Authentication and Security Options: Specifies the kind of authentication required for incoming requests from the QL Web Service. Specifies whether or not incoming connections from the QL Web Service are required to be made over a secure socket layer (via HTTPS).
Sample Query: A sample query that developers can run via the QL Web Service to get information back from the web data source connection.
QL Data Structure: Instructions on how the QL Web Service should create URLs that access the data available from the web data source connection. A QL Open Data Table definition provides the QL Web Service with the URL location of the web data source, along with the individual query parameters (keys) available to the QL Web Service.
Pagination Options: Specifies how the QL Web Service should “page” through results. If the web data source can provide staggered results, paging will allow the QL Web Service to limit the amount of data returned.

The QL Web Service provides the QL USE statement to access external data via QL Open Data Tables. A single QL Open Data Table can be accessed as indicated in the following example QL USE statement:
USE “http://myserver.com/mytables.xml” AS mytable;
SELECT*FROM mytable WHERE . . .

In the above QL statement, USE precedes the location of the QL Open Data Table definition, which is then followed by AS and the table name to be associated with the specified QL Open Data Table definition. After the semicolon, the QL statement is formed as discussed above with regard to the QL SELECT statement. In the above example, the QL Web Service fetches the URL indicated by the USE statement and makes it available as a table named mytable in the current request scope. The statements following use can then select or describe the particular table using the name mytable.

Multiple QL Open Data Tables can be invoked by using multiple USE statements, as shown in the following example:
USE “http://myserver.com/mytables1.xml” as table1;
USE “http://myserver.com/mytables2.xml” as table2;
SELECT*FROM table1 WHERE id IN (select id FROM table2)

Additionally, a QL environment file can be defined to specify use of multiple QL Open Data Tables. The QL environment file provides for use of multiple tables at once without having to specify the USE verb in the QL statements. The QL environment file is a text file that contains a list of USE and SET statements, typically ending with a “.env” suffix. An example QL environment file may appear as follows:
USE ‘http://www.datatables.org/amazon/amazon.ecs.xml’ AS amazon.ecs;
USE ‘http://www.datatables.org/bitly/bit.ly.shorten.xml’ AS bit.ly.shorten;
USE http://www.datatables.org/delicious/delicious.feeds.popular. zml’ AS delicious.feeds.popular;
USE ‘http://www.datatables.org/delicious/delicious.feeds.xml’ AS delicious.feeds;
USE ‘http://www.datatables.org/dopplr/dopplr.auth.xml’ AS dopplr.auth;
USE ‘http://www.datatables.org/dopplr/dopplr.city.info.xml’ AS dopplr.city.info;
USE http://www.datatables.org/dopplr/dopplr.futuretrips.info.xml’ AS dopplr.futuretrips.info;
USE http://www.datatables.org/dopplr/dopplr.traveller.fellows.xml’ AS dopplr.traveller.fellows;

Once the QL environment file is uploaded to the developer's server, the developer can simply access the QL Web Service and append the location of the file as follows:
http://developer.yahoo.com/yql/console/?env=http://datatables.org/alltables.env

Also, multiple QL environment files can be utilized at once by using multiple “env” query parameters. The multiple QL environment files are loaded in the order they appear in the query string. For example:
http://developer.yahoo.com/yql/console/?env=http://datatables.org/alltables.env&env=http://website.com/mytable.env

The QL Web Service provides for the set up of key values for use within QL Open Data Tables. For example, it is possible to set values, such as passwords, API keys, and other required values, independently of QL statements and API calls. The following example sets the api_key value within the QL statement itself:
select*from guardian.content.search where api_key=“1234567890” and q=‘environment’

The SET keyword allows you to set key values outside of a QL statement, including within QL environment files. The SET keyword uses the following syntax within a QL environment file:
SET api_key=“1234567890” ON guardian;

In the example above, SET is followed by the key (api_key) and its value (1234567890), and the prefix (guardian) of the table is specified. Once a key value is set within an environment file, the key value is removed from the QL statement, as follows:
select*from guardian.content.search where query=“environment”

In one embodiment, the following precedence rules apply when setting key values with the SET keyword:
Keys that are set within the QL statement take precedence over keys that are set using the SET keyword.
If the set key is multiply defined, the most precise definition, based on the length of the table prefix, takes precedence.
If the set key is multiply defined at the same preciseness, the last definition is used.

The SET keyword can be used to hide key values or data. More specifically, to avoid exposing private data when sharing QL Open Data Tables, a combination of QL features can be used to hide such data, as follows:
1. Add private values to an environment file using the SET keyword.
2. Use the yql.storage.admin table to import the environment file or QL Open Data Table with a memorable name. The QL Web Service provides a set of shared access keys.
3. Use the shared execute or select access keys in lieu of either a QL Open Data Table, environment file, or JavaScript.

The QL Web Service is defined to support a structured arrangement of elements and sub-elements within a QL Open Data Table. In one embodiment, the available QL Open Data Table elements and sub-elements include the following, which are described in detail below:
table (The root element of the QL Open Data Table.)
table/meta
table/bindings/select
table/bindings/insert
table/bindings/update
table/bindings/delete
table/bindings/select/urls/urls
table/bindings/select/execute
table/bindings/[select/insert/update/delete]/inputs/key
table/bindings/[select/insert/update]/inputs/value
table/bindings/[select/insert/update/delete]/inputs/map
table/bindings/select/paging
table/bindings/select/paging/pagesize
table/bindings/select/paging/start
table/bindings/select/paging/total
table/bindings/select/paging/nextpage.

The table element is the root element for the document. A table is the level at which an end-user can “select” information from QL web data sources. A table can have many different bindings or ways of retrieving the data. In one embodiment, a single table provides a single type of data. The following is an example specification of the table element:
<table xmlns=“http://query.yahooapis.com/v1/schema/table.xsd”>

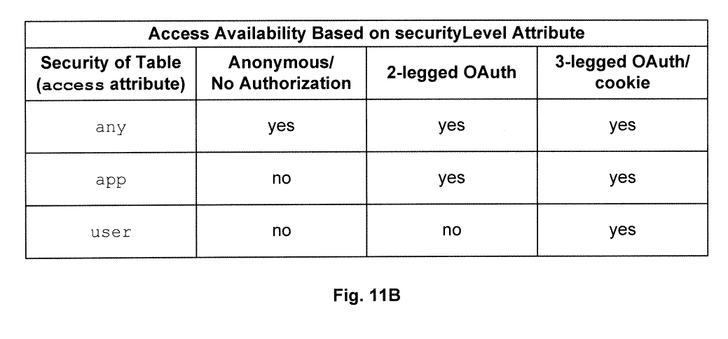

In the above example, xmlns is an attribute of the table element. FIG. 11A shows a listing of attributes available for specification in association with the table element, in accordance with one embodiment of the present invention. It should be understood that in other embodiments, the table element may have more or less available attributes than those specifically shown in FIG. 11A.

The securityLevel attribute of the table element, as listed in FIG. 11A, determines the type of authentication required to establish a connection. In order for a user to connect to the QL Open Data Table, the user must be authorized at the level or higher than the level indicated in the securityLevel attribute. FIG. 11B shows a table that lists whether access is available depending on the value in the securityLevel attribute.

In addition to the table element, the QL Open Data Table is required to include the meta sub-element. The following is an example specification of the meta sub-element:

```
<meta>
  <author>Yahoo! Inc.</author>
  <documentationURL>http://www.flickr.com/services/a
pi/flickr.photos.search.html</documentationURL>
  <sampleQuery>select * from {table} where
has_geo=“true” and text=“san francisco”</sampleQuery>
</meta>
```

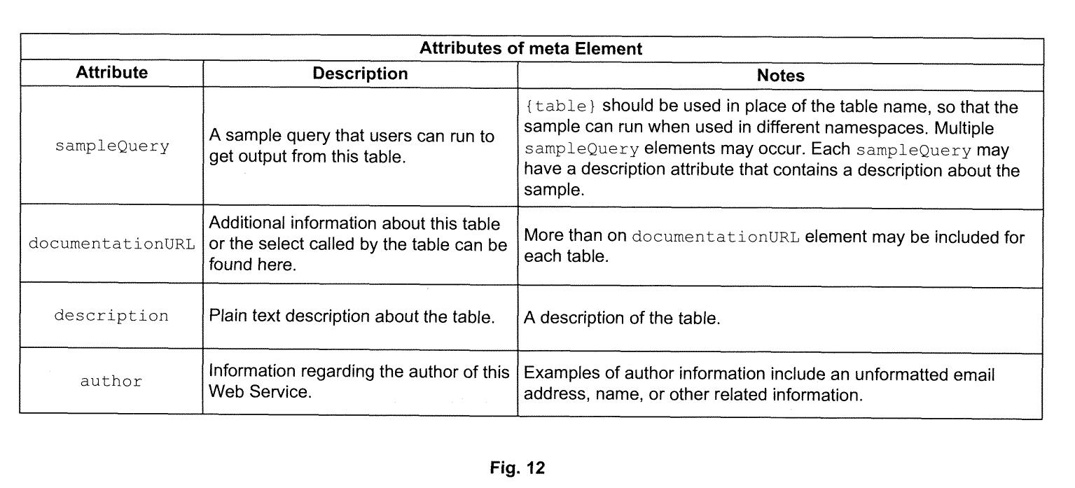

In the above example, author, documentationURL, and sampleQuery are attributes of the meta sub-element. FIG. 12 shows a listing of attributes available for specification in association with the meta sub-element, in accordance with one embodiment of the present invention. It should be understood that in other embodiments, the meta sub-element may have more or less available attributes than those specifically shown in FIG. 12.

Situated within each bindings element, is one of four keywords: select, insert, update, or delete. The select element describes the information needed for the QL Web Service to read data from an API. The insert and update elements describe the information needed to add or modify data from an API, respectively. When removing data, the delete element is used to describe the necessary bindings.

When a keyword such as select or update is repeated within the bindings array, it can be considered to be an alternative way for the QL Web Service to call a remote server to get the same type of structured data. Typically, this is used when the service supports different sets of query parameters (QL's “keys”) or combinations of optional query parameters.

Unlike XML, JSON objects have no “root” node. To work with the dot notation, the QL Web Service creates a “pseudo” root node for JSON responses called “json”. If it is necessary to return a sub-structure from a QL Open Data Table that fetches or produces JSON, “json” should be added at the root of the path.

The following is an example specification of the bindings/select element:

```
<bindings>
  <select itemPath=“rsp.photos.photo”
produces=“XML”>
  ...
</bindings>
```

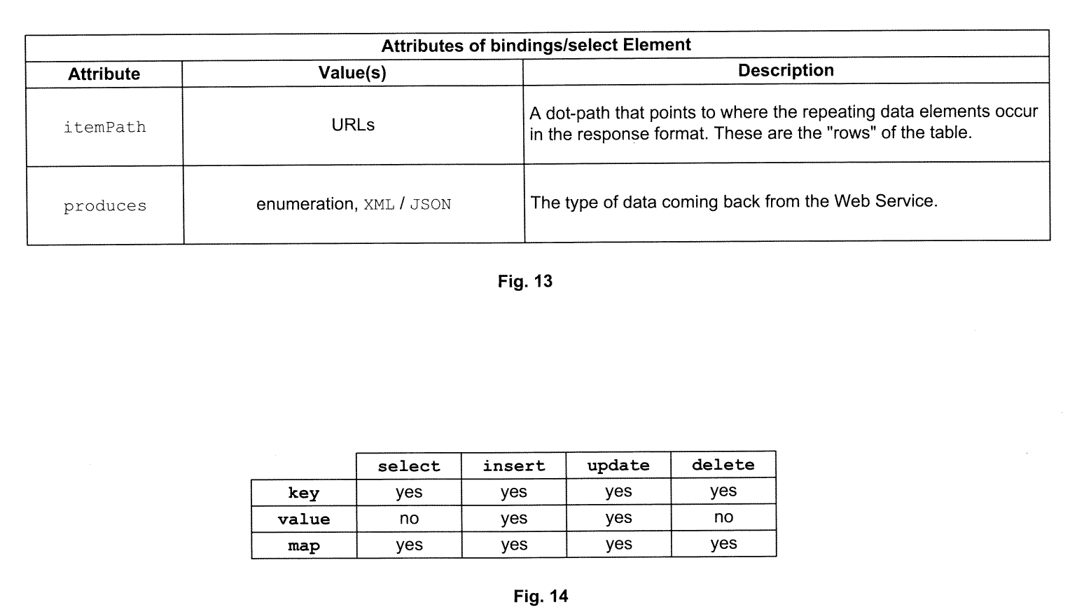

In the above example, itemPath is an attribute of the bindings/select element. FIG. 13 shows a listing of attributes available for specification in association with the bindings/select element, in accordance with one embodiment of the present invention. It should be understood that in other embodiments, the bindings/select element may have more or less available attributes than those specifically shown in FIG. 13.

The table/bindings/select/urls/urls element (referred to as the “urls” element) is where the QL Web Service and the QL Open Data Table supporting the back-end web data source come together. The url element describes the URL that needs to be executed to get data for the particular QL Open Data Table, given the keys in the key elements. While generally there is only one URL specified, if a particular web data service supports a “test” select and it is desirable to expose it, an additional urls element can be added for that environment.

The CDATA/TEXT for the urls element contains the URL itself that utilizes substitution of values at runtime based on the uri template spec. The names of the values will be substituted and formatted according to the uri template spec, but one method is to enclose a key name within curly braces ({}) All {name} keys found in the URL will be replaced by the same id key value in the keys elements. The QL Web Service currently supports both http and https protocols. An example of this is shown as follows:
https://prod.gnipcentral.com/publishers/{publisher}/notification/{bucket}.xml

In the above example, the QL Web Service will look for key elements with the names publisher and bucket. If the QL statement developer does not provide those keys in the WHERE clause (and they are not optional), then the QL Web Service detects the problem and will produce an error. If an optional variable is not provided, but is part of the QL Open Data Table definition, it will be replaced with an empty string. Otherwise, the QL Web Service will substitute the values directly into the URL before executing it.

The table/bindings/select/execute element (referred to as the “execute” element) allows for invocation of server-side JavaScript in place of a GET request. An example of the execute element is shown as follows:

```
<execute>
  <![CDATA[
  // Include the flickr signing library
  y.include(“http://blog.pipes.yahoo.net/wp-
content/uploads/flickr.js”);
  // GET the flickr result using a signed url
  var fs = new flickrSigner(api_key,secret);
  response.object =
y.rest(fs.createUrl({method:method,format:“”})).get( ).r
esponse( );
]]>
</execute>
```

By way of the execute element, it is possible to embed JavaScript and E4X (the shortened term for EcmaScript for XML), which adds native XML support to JavaScript. When a QL statement calls a QL Open Data Table having a definition that includes the execute element, the QL Web Service does not perform the request to the templated URI in the endpoint. Rather, the QL Web Service provides a runtime environment in which the JavaScript is executed server-side. The JavaScript in turn is required to return data as the output to the original QL statement.

The ability to execute JavaScript via the execute element extends the functionality of QL Open Data Tables in many ways, including the following:
Flexibility beyond the normal templating within QL Open Data Tables: Executing JavaScript allows you to use conditional logic and to format data in a granular manner.
Data shaping and parsing: Using JavaScript, you can take requests and responses and format or shape them in way that is suitable to be returned.
Support for calling external Web services: Some Web services use their own security and authentication mechanisms. Some also require authentication headers to be set in the Web service request. The execute element allows you to do both.
Support for adding, modifying, and deleting data using external Web services: For Web services that support write access, the QL Web Service allows you to insert, update, and delete using server-side JavaScript within the insert, update, and delete elements, which are nested within the binding element.

Each of the following elements is referred to as an “inputs” element:
table/bindings/[select/insert/update/delete]/inputs/key
table/bindings/[select/insert/update]/inputs/value
table/bindings/[select/insert/update/delete]/inputs/map

In one embodiment, there are three types of elements available within the inputs element: key, value, and map. Each key element represents a named “key” that can be provided in the WHERE or INTO clause of QL SELECT, INSERT, UPDATE, or DELETE statements. The QL Web Service inserts these values into the URL request before it is sent to the server. The QL Web Service inserts these values into the URL request if the paramType is set to query or path or header. For a variable type, the key named as the id of the element is made available in the execute section of the QL Open Data Table.

The value element can be used to assign a new “value” or update an existing value within a QL Open Data Table. The value element defines a field that can only be set as an input and therefore cannot be in QL statements to satisfy the WHERE clause. The value element only works with the INSERT and UPDATE verbs and in different ways.

When used with the insert keyword, the value element appears in the VALUE expression of the QL statement, indicating that a new value is being passed into the QL statement, as seen in the following example:
INSERT into bitly.shorten (login, apiKey, longUrl) VALUES (‘YOUR_LOGIN’, ‘YOUR_API_KEY’, ‘http://yahoo.com’)

When used with the update keyword, the value element is called from the SET portion of the QL statement. This indicates that you are “setting” a particular value, as seen in the following example:
UPDATE table SET status=‘Reading the YQL Guide’ where guid=me;

The map element enables use of dynamic keys. With the map element, the QL Web Service uses the value passed in through the QL statement as a variable. This variable is used within the execute portion of the QL Open Data Table to determine what action to take. For example, you may set up a QL Open Data Table that updates either bit.ly, delicio.us, or tinyurl, depending on the value specified in the QL statement. For a dynamic key called type, the actual ID in a QL query would look like the following:
field.type=‘Java’

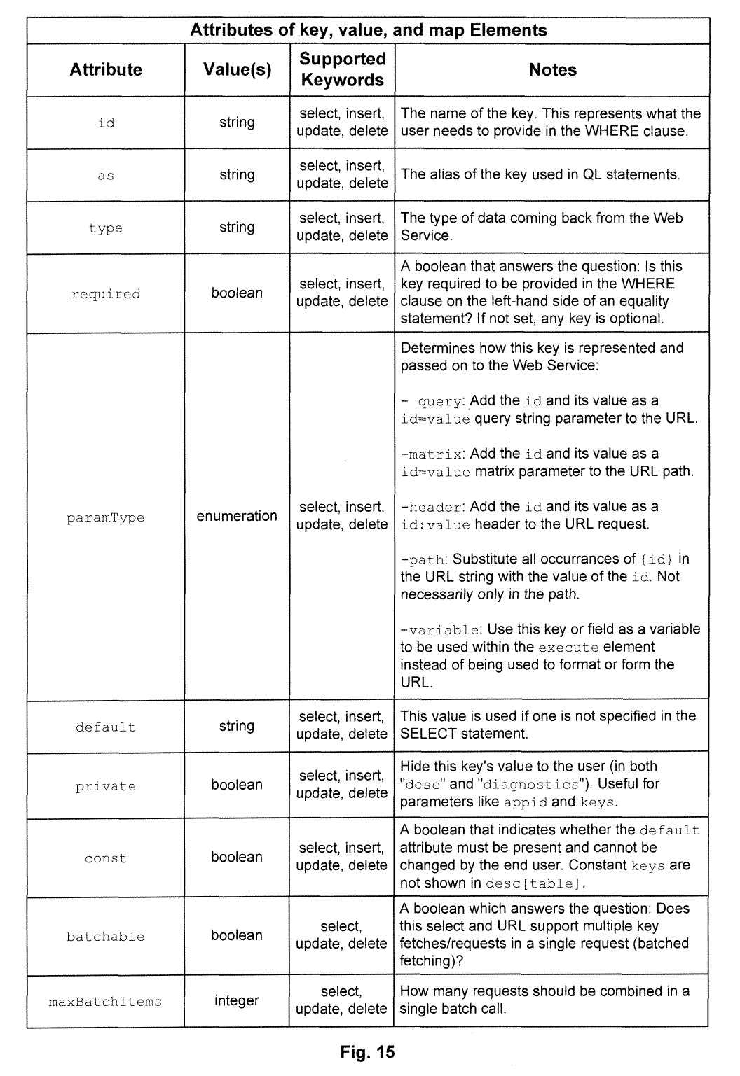

In the absence of the map element as a binding, all identifiers, not corresponding to a binding element and that appear in a QL query, are treated as local filters. The map element can be used for each of the paramTypes: query, matrix, header, path, and variable, as described in FIG. 15. The following is an example of the map element being used in a path:
<map id=“field” paramType=“path”/>

For a query containing the relational expression field.type=‘rss’, only the dynamic parameter name type would be substituted in the urls element. The URI template would look like the following:
http://rss.news.yahoo.com/{type}/topstories

The following is an example specification of the inputs element:

```
<inputs>
  <key id=‘guid’ type=‘xs:string’ paramType=‘path’
required=“true”/>
  <key id=‘ck’ type=‘xs:string’ paramType=‘variable’
required=“true” />
  <key id=‘cks’ type=‘xs:string’
paramType=‘variable’ required=“true” />
  <value id=‘content’ type=‘xs:string’
paramType=‘variable’ required=“true” />
</inputs>
```

In the above example, key and value are elements under the inputs element. FIG. 14 shows a table indicating which keywords (select, insert, update, delete) support the key, value, and map elements, in accordance with one embodiment of the present invention. FIG. 15 shows a table listing the attributes available within the key, value, and map elements, in accordance with one embodiment of the present invention.

The QL Web Service provides for aliasing within the key, value, and map elements. For instance, if there is an obscurely named id in the QL Open Data Table, an alias can be defined and used to refer to it within QL statements. For example, perhaps an id called “q” is present within the QL Open Data Table, which actually is a search parameter. The term “as” can be used to create an alias in the following way:
<key id=“q” as=type=“xs:string” paramType=“query”/>
select*from google.search where search=“pizza”

The table/bindings/select/paging element (referred to as the “paging” element) describes how the QL Web Service should “page” through the web data source results, if they span multiple pages, or the service supports offset and counts. An example of the paging element is shown as follows:

```
<paging model=“page”>
  <start id=“page” default=“0” />
  <pagesize id=“per_page” max=“250” />
  <total default=“10” />
</paging>
<paging model=“url”>
  <nextpage path=“ysearchresponse.nextpage” />
</paging>
```

The paging element includes an attribute model that is used to specify the type of model to use to fetch more than the initial result set from the web data service. The attribute model can be set equal to a literal value of either offset, page, or url. The offset value refers to services that allow arbitrary index offsets into the result set. The page value is used for services that support distinct “pages” or some number of results. The url value is used for services that support a URL to access further data, e.g., to access the next page of data. When the url paging model is used, the pagesize element (discussed below) may be used to adjust the number of results returns at once, if the web data service allows.

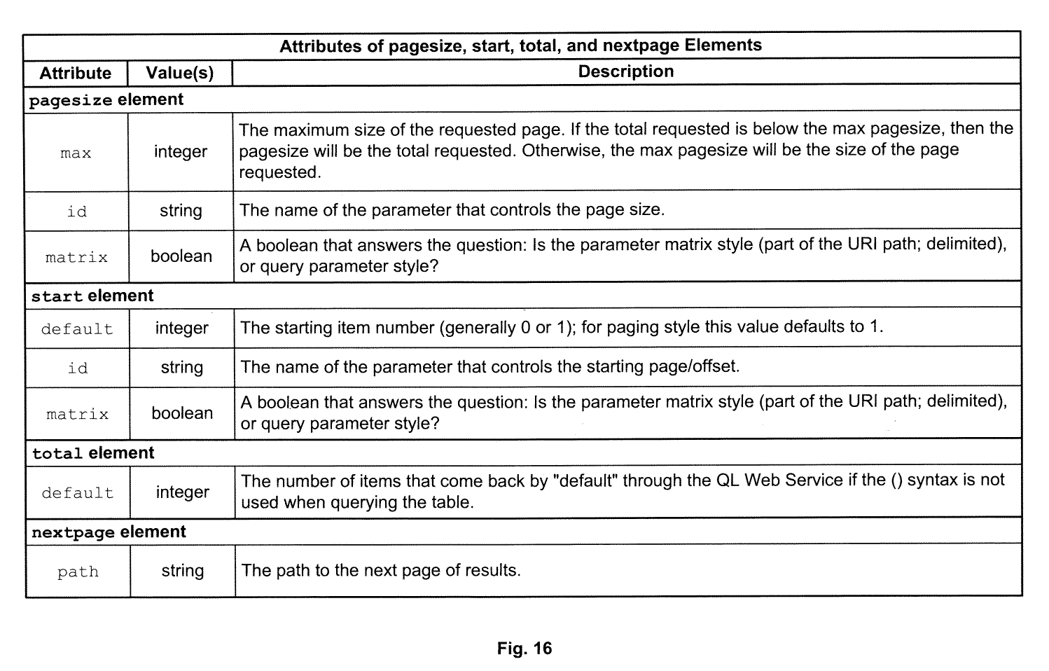

The paging element includes the following sub-elements: pagesize, start, total, and nextpage. The pagesize element provides information about how the number of items per request can be specified. The start element provides information about how the “starting” item can be specified in the set of results. The total element provides information about the total number of results available per request by default. The nextpage element provides information about the location of the next page of results. The nextpage element is an optional element used in conjunction with the parent url element. FIG. 16 shows a table listing the attributes available within the pagesize, start, total, and nextpage elements, in accordance with one embodiment of the present invention.

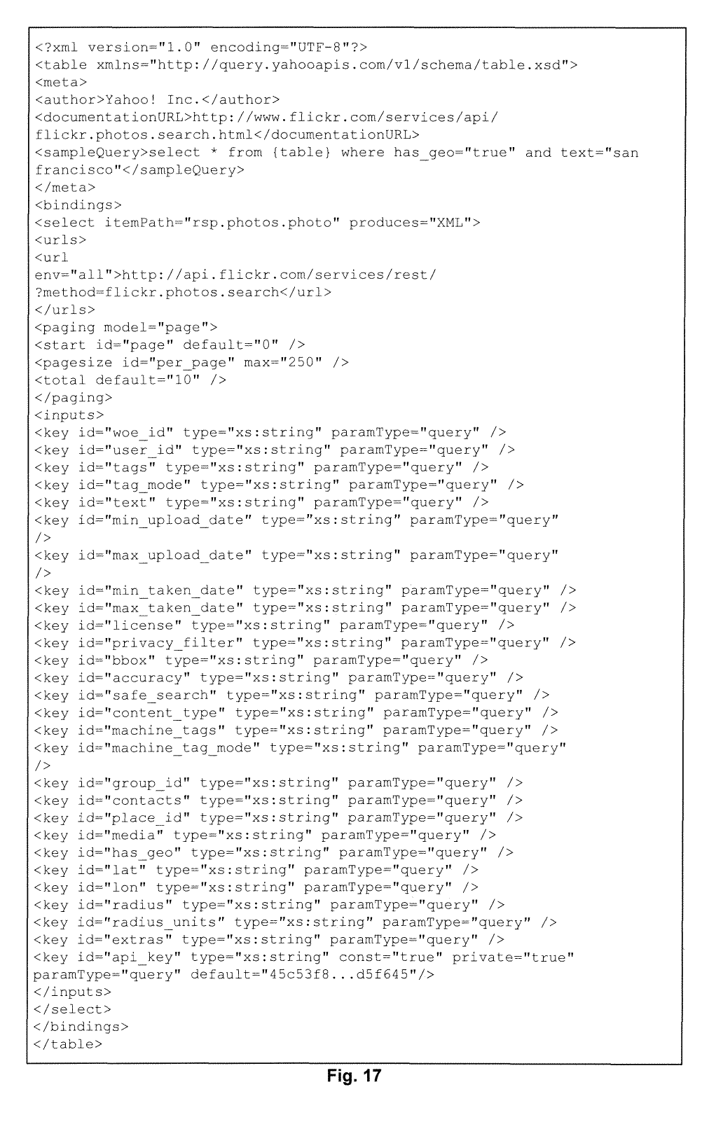

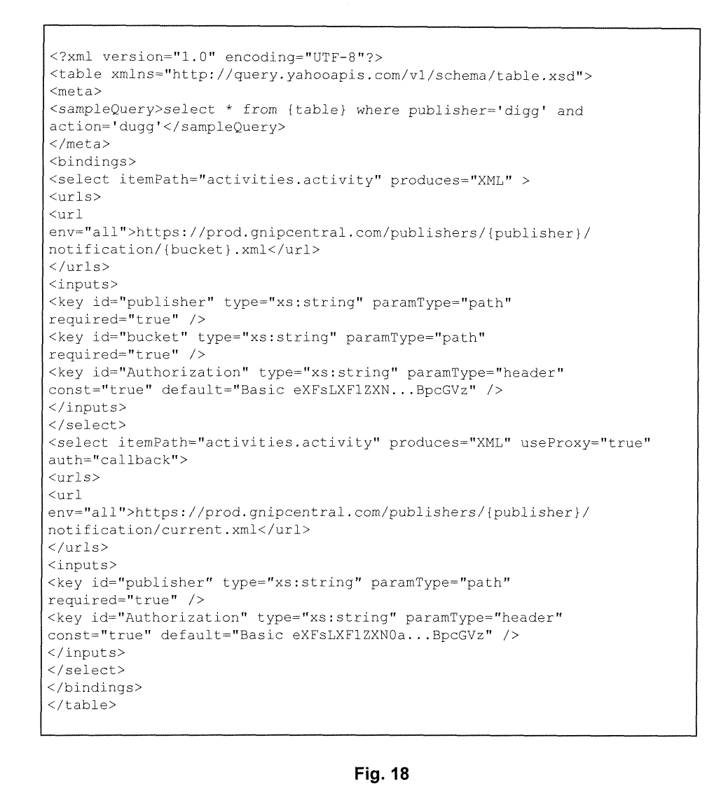

FIG. 17 shows an example QL Open Data Table defined to tie into the Flickr API and allow the QL Web Service to retrieve data from a Flickr photo search, in accordance with one embodiment of the present invention. FIG. 18 shows an example QL Open Data Table defined to the Gnip API to retrieve activities from a Publisher, which in this example is Digg, in accordance with one embodiment of the present invention.

The QL SELECT statement allows for reading of structured data from almost any source on the Web. To perform data manipulation, the QL Web Service provides three other keywords (INSERT, UPDATE, DELETE) for writing, updating, and deleting, respectively, data mapped using a QL Open Data Table. The QL INSERT statement inserts or adds new data to a back-end data source associated with a QL table. The QL UPDATE statement updates or modifies existing data at a back-end data source associated with a QL table. The QL DELETE statement removes data from a back-end data source associated with a QL table. It should be understood that the INSERT, UPDATE, and DELETE operations are performed on back-end data sources and are performed independently from the SELECT operation. The INSERT, UPDATE, DELETE statements require the proper binding inputs, such as key, value, or map. The actual addition, modification, or deletion of data is performed within the QL Open Data Table. Most web sources that provide write capability need authentication. Examples of authentication include username/password combinations or secret API tokens. If the QL table requires input that is deemed “private”, such as any passwords, authentication keys, or other “secrets”, the https attribute within the tables element should be set to true.

The INSERT, UPDATE, DELETE statements rely entirely on appropriate bindings within a QL Open Data Table to be usable. Specifically, it is necessary to use an insert, update, or delete bindings element. These binding elements help to determine what happens with the information you pass in through a QL statement. For Web services that require specific authentication methods or specific types of HTTP requests, the QL Web Service provides several JavaScript methods for use within the execute element, including:
Methods that allow HTTP PUT, POST, and DELETE requests, in addition to GET.
The ability to specify the content type on data being sent, using contentType.
The ability to automatically convert the data being returned using accept.

The QL INSERT statement has the following syntax:
INSERT INTO (table) (list of comma separated field names) VALUES (list of comma separated values)

The INSERT INTO keywords marks the start of an INSERT statement. The table is either a QL built-in table or a QL Open Data Table that represents a data source. Following the table name is a list of field names indicating the table columns where the QL Web Service inserts a new row of data. The VALUES clause indicates the data inserted into those columns. String values are enclosed in quotes. In one embodiment of the QL Web Service, statement keywords such as SELECT and WHERE are case-insensitive. Table and field names are case sensitive. In string comparisons, the values are case sensitive. String literals are enclosed in quotes. Either double or single quotes are allowed.

The QL UPDATE statement has the following syntax:
UPDATE (table) SET field=value WHERE filter

The UPDATE keyword marks the start of an UPDATE statement. This is followed by the table name. The table is either a QL built-in table or a QL Open Data Table that represents a data source. The SET clause is the part of the statement in which new data is passed to the update binding in the QL Open Data Table. The WHERE clause indicates which data should be updated. In one embodiment, only remote filters can be present in the WHERE clause of an UPDATE statement. The following example shows how the UPDATE statement syntax can look for updates to a user's status on Yahoo! Profiles:
UPDATE social.profile.status SET status=“Using YQL UPDATE” WHERE guid=me

In the above example, status and guid are all bindings within the inputs element, which is nested within an update element. The status is a value element, since this is data that is updating a value using the QL Open Data Table. The guid binding is a key element, as it is a required “key” that determines ownership of this status.

The QL DELETE statement has the following syntax:
DELETE FROM [table] WHERE filter

The DELETE keyword marks the start of a DELETE statement. The table is either a QL built-in table or a QL Open Data Table that represents a data source. This is immediately followed by a remote filter that determines what table rows to remove. The following example deletes a particular Twitter tweet, wherein the remote filters are the ID of the tweet followed by the username and password for the owner of the tweet:
DELETE FROM twittertable WHERE tweetid=“12345” and username=“twitter_username” and password=“twitter_password”

As discussed above, the QL Web Service includes the following features, among many others:
The QL Web Service hides the complexity of Web service APIs by presenting data as simple tables, rows, and columns.
The QL Web Service includes pre-defined, i.e., built-in, tables for popular Yahoo! Web services such as Flicks, Social, MyBlogLog, and Search, among others.
The QL Web Service can access services on the Internet that output data in the following formats: HTML, XML, JSON, RSS, Atom, and microformat, among others.
The QL Web Service is extensible, allowing user's to define QL Open Data Tables to access data sources other than Yahoo! Web Services. This feature enables a user to combine data from multiple Web services and APIs, and expose the combined data as a single QL table.
The QL Web Service provides multiple selectable output formats for the results returned by requests to the QL Web Service, such as XML and JSON formats.
The QL Web Service allows sub-selects, which enables the joining of data from disparate data sources on the Web. The QL Web Service returns the data in a structured document, with elements that resemble rows in a table.
The QL Web Service provides a WHERE clause to enable filtering of the data returned through execution of a QL statement.
The QL Web Service provides for paging through returned results, thereby enabling efficient processing of data from large tables.
The QL Web Service is defined to work out the most efficient way of dispatching multiple network calls at the same time, i.e., in parallel, to collect data together for subsequent conveyance to the caller of the QL Web Service. Therefore, the QL Web Service efficiently parallelizes and dispatches network calls across the multiple back-end web data source systems. This is particularly beneficial with regard to joining of data from multiple web data sources.
The QL table does not need to describe every single permutation of calling the back-end web data source with which it is associated. Also, the QL table does not need to describe data acquired from the back-end data source beyond a simple type specification.

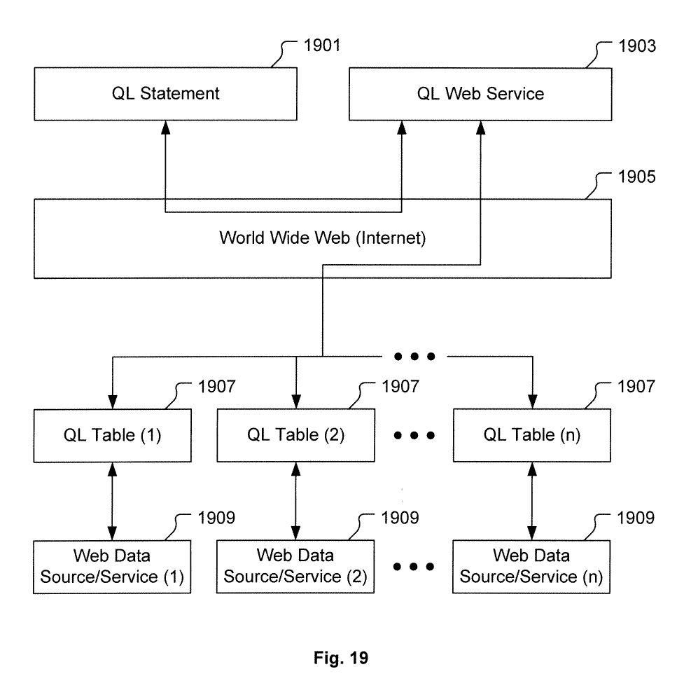

FIG. 19 shows an architectural view of the QL Web Service system, in accordance with one embodiment of the present invention. The QL Web Service system architecture includes a QL statement 1901 generated by a developer, i.e., user of the QL Web Service. The QL statement 1901 is described in detail above. The QL statement 1901 is transmitted via the World Wide Web (Internet) 1905 to the QL Web Service 1903, using an appropriate URL entry point to the QL Web Service 1903. As discussed above, the QL Web Service is a system defined to provide a structured interface via the QL to diverse web data sources/services that are accessible through the Internet 1905. By way of the QL, the QL Web Service operates to abstract the complexities and details associated with varied web data sources/services, such that the developer can use the QL to access and consume data available through the varied web data sources/services without having to know the intricacies associated with accessing and consuming the varied web data sources/services.

The QL Web Service 1903 is defined to process the QL statement 1901 and perform the operations directed by the QL statement 1901, by accessing a URL addressed QL table 1907 via the Internet 1905. As discussed above, the QL table 1907 is a structured file defined to bind a particular web data source/service 1909 to the QL Web Service 1903. By way of the QL table 1907, the QL Web Service 1903 is informed as to how the particular web data source/service 1909 can be accessed and consumed, thereby binding the particular web data source/service 1909 to the QL Web Service 1903.

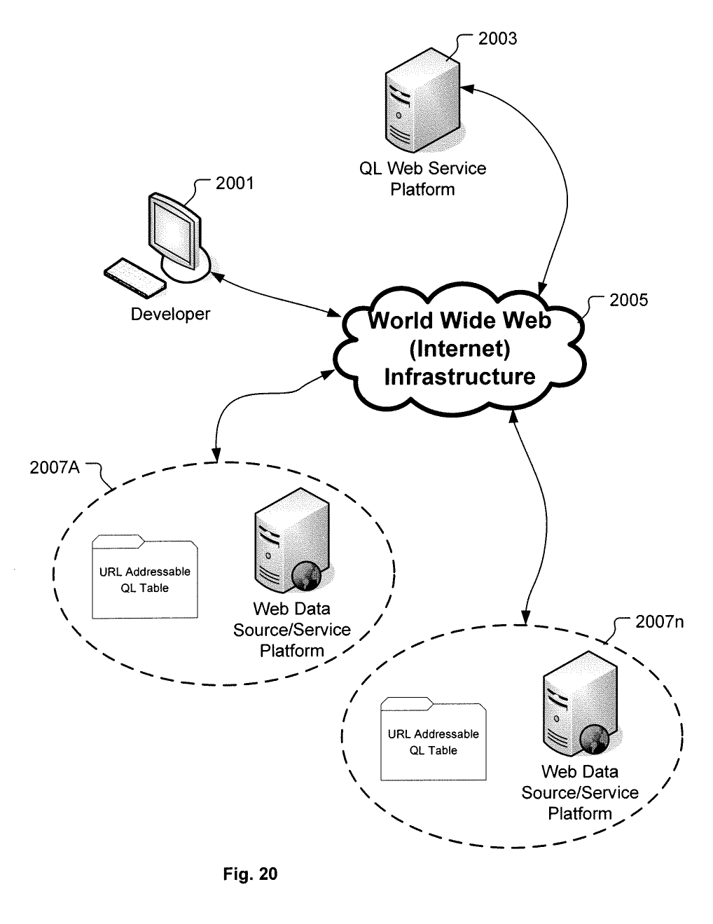

FIG. 20 shows a system level view of the QL Web Service, in accordance with one embodiment of the present invention. Essentially, the system level view of FIG. 20 is a physical representation of the architectural view of the QL Web Service system as described with regard to FIG. 19. The developer creates the QL statement 1901 at a remote terminal 2001. Using a URL to the QL Web Service 1903, the developer's QL statement 1901 is transmitted to the QL Web Service platform 2003 via the Internet 1905. It should be understood that the Internet 1905 is defined by an Internet infrastructure 2005 that includes a network of interconnected computer hardware, e.g., switches, routers, servers, cables, transmitters, receivers, etc., and computer software and firmware, which operate in concert to transmit data from node-to-node throughout the universe of computing systems that are connected to the Internet infrastructure 2005, by either wired or wireless means.

The QL Web Service platform 2003 is defined to execute the QL Web Service 1903. As such, the QL Web Service platform 2003 is defined to connect via the Internet 2005, with any of a number of computing nodes (2007A-2007n) that contains a QL table addressed by a particular URL. Additionally, based on the binding of a web data source/service by the QL table, the QL Web Service platform 2003 is defined to connect via the Internet 2005, with any of a number of computing nodes (2007A-2007n) representing the platform that serves the web data source/service associated with the QL table. Through this connection, the QL Web Service 1903 can access and consume the web data source/service associated with the QL table, as requested by the QL statement received at the QL Web Service platform 2003 from the developer 2001.

A system is disclosed herein for querying web data. The system includes a web data source including data to be queried. The web data source is defined in either an HTML format, an XML format, a JSON format, an RSS format, an Atom format, or microformat, among others. The system also includes a query language (QL) web service defined to expose a QL for specification of the web data source, including data to be queried and one or more operations to be performed on the web data source. Requirements specific to the web data source for accessing and performing operations on the web data source are abstracted through the exposed QL. The QL web service is accessible through a QL web service URL. The QL web service URL is either a public URL enabling access to public web data sources or a private URL enabling access to both public and private web data sources. The system further includes a QL table associated with the web data source. The QL table is accessible through a universal resource locator (URL). The QL table includes binding data which binds the web data source to the QL web service. The binding data includes instructions to the QL web service with regard to creating URLs to access and retrieve data from the web data source.

The QL web service is defined to query data within the web data source, retrieve data from the web data source based on the query, filter the retrieved data, and format the retrieved and filtered data. The QL web service is also defined to transform the retrieved data from a format in which it exists at the web data source into a different specified format. In one embodiment, the QL web service is defined to convey the retrieved data in a tabular arrangement in either an XML format or a JSON format. The XML format specifies XML elements as rows of the tabular arrangement and specifies XML sub-elements or XML attributes as columns of the tabular arrangement. The JSON format specifies JSON objects as rows of the tabular arrangement and specifies JSON name-value pairs as columns of the tabular arrangement. The QL web service is also defined to filter the data retrieved from the web data source according to one or more remote filters, one or more local filters, or a combination thereof. Remote filters are applied to data at the web data source. Local filters are applied to data at the QL web service. Additionally, the QL web service is defined to query data within the web data source in accordance with paging specifications.

It should be appreciated that the system for querying web data can include multiple web data sources each including respective data to be queried, and multiple QL tables respectively associated with the multiple web data sources. The QL web service is defined to use binding data in the multiple QL tables to simultaneously access and retrieve data from the multiple web data sources that are respectively associated with the multiple QL tables, and return the data retrieved from the multiple web data sources in a combined format. The multiple web data sources from which data is retrieved can be defined in accordance with different data formats. The QL web service is defined to join multiple web data sources by providing for use of one or more key identifiers returned in a first set of queried data, resulting from a first query of a first web data source, as input parameters in a second query of a second web data source. In this manner, a second set of queried data resulting from the second query is based on the one or more key identifiers returned in the first set of queried data.

A method is disclosed herein for querying web data. The method includes an operation for generating a query language (QL) statement defined to identify one or more QL tables respectively associated with one or more web data sources, and to specify one or more actions to be performed on the one or more web data sources. The QL statement is formatted in accordance with a QL syntax. The method also includes an operation for embedding the generated QL statement within a universal resource locator (URL) directed to a QL web service. The URL directed to the QL web service is executed within an Internet browser such that the QL statement embedded in the URL is executed by the QL web service.

The method continues with processing the QL statement through the QL web service, whereby the QL web service accesses the one or more QL tables identified in the QL statement through the Internet and retrieves direction from the one or more QL tables regarding access and retrieval of data from the one or more web data sources respectively associated with the one or more QL tables identified in the QL statement. Based on the direction retrieved from the one or more QL tables, the QL web service is operated to access the one or more web data sources respectively associated with the one or more QL tables and perform the one or more actions on the one or more web data source as specified in the QL statement. The method further includes an operation for conveying a result of the one or more actions performed on the one or more web data sources by the QL web service to the Internet browser in which the URL directed to the QL web service was executed. The result can be conveyed as textual data in visual form, such as within a display of a computer system. Also, the result can be conveyed as digital data to be stored and processed by a computer system.

Another method is disclosed herein for binding web data to a web data query system. The method includes an operation for creating a structured file that includes information to bind a web data source to the system for querying web data. In one embodiment, the structured file is defined in an XML format. The information in the structured file includes authentication and security specifications indicating a type of authentication required for the web data query system to access the web data source, and indicating whether or not the web data query system is required to access the web data source over a secure connection. The information in the structured file also includes instructions for how the web data query system should create universal resource locators (URLs) that access data available from the web data source. The method also includes an operation for associating a URL with the structured file to enable access of the structured file through the Internet. The method further includes an operation for storing the structured file on a computer readable storage medium such that the structured file is accessible through the Internet by way of the URL associated with the structured file.

In the above method, the instructions for how the web data query system should create URLs that access data available from the web data source includes a web data source URL and specification of query parameters that are available to access particular data within the web data source. Additionally, the information included within the XML file includes pagination options specifying how the web data query system should traverse through the data available from the web data source. Also, the information included within the XML file further includes a sample query that is executable by the web data query system to demonstrate how data can be retrieved from the web data source.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, and other optical and non-optical data storage devices. The computer readable medium can also be distributed over a network coupled computer systems so that the computer readable code may be stored and executed in a distributed fashion.

Although the method operations of various embodiments disclosed herein were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overall operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for querying web data, comprising:
a web data source including data to be queried;
a query language (QL) web service defined to expose a QL for specification of the web data source including data to be queried and one or more operations to be performed on the web data source, wherein requirements specific to the web data source for accessing and performing operations on the web data source are abstracted through the exposed QL; and
a QL table associated with the web data source, wherein the QL table is accessible through a universal resource locator (URL), and wherein the QL table includes binding data which binds the web data source to the QL web service, the binding data including instructions to the QL web service with regard to querying the web data source for specific data present at the web data source.

2. The system for querying web data as recited in claim 1, wherein the QL provides for specification of the web data source including data to be queried and one or more operations to be performed on the web data source in a single query statement.

3. The system for querying web data as recited in claim 1, wherein the web data source is defined in either an HTML format, an XML format, a JSON format, an RSS format, an Atom format, or microformat.

4. The system for querying web data as recited in claim 1, wherein the QL web service is defined to query data within the web data source, retrieve data from the web data source based on the query, filter the retrieved data, and format the retrieved and filtered data.

5. The system for querying web data as recited in claim 4, wherein the QL web service is defined to transform the retrieved data from a format in which it exists at the web data source into a different specified format.

6. The system for querying web data as recited in claim 5, wherein the QL web service is defined to convey the retrieved data in a tabular arrangement in either an XML format or a JSON format, wherein the XML format specifies XML elements as rows of the tabular arrangement and specifies XML sub-elements or XML attributes as columns of the tabular arrangement, and wherein the JSON format specifies JSON objects as rows of the tabular arrangement and specifies JSON name-value pairs as columns of the tabular arrangement.

7. The system for querying web data as recited in claim 4, wherein the QL web service is defined to filter the data queried from the web data source according to one or more remote filters, one or more local filters, or a combination thereof, wherein remote filters are applied to data at the web data source, and wherein local filters are applied to data at the QL web service.

8. The system for querying web data as recited in claim 4, wherein the QL web service is defined to query data within the web data source in accordance with paging specifications defined at the QL web service, wherein the paging specifications defined at the QL web service are applied independently from paging specifications local to the web data source.

9. The system for querying web data as recited in claim 8, wherein the paging specifications defined at the QL web service include one or more of a remote offset specification, a remote limit specification, a local offset specification, and a local limit specification, wherein the remote offset and limit specifications are applied to data at the web data source, and wherein the local offset and limit specifications are applied to data at the QL web service.

10. The system for querying web data as recited in claim 1, further comprising:
additional web data sources each including respective data to be queried; and
additional QL tables respectively associated with the additional web data sources,
wherein the QL web service is defined to execute a single query statement which directs the use of binding data in multiple QL tables to simultaneously query data from multiple web data sources respectively associated with the multiple QL tables, and return the queried data from the multiple web data sources in a combined format as a single set of results data.

11. The system for querying web data as recited in claim 10, wherein the QL web service is defined to join a plurality of the web data sources by providing for use of one or more key identifiers returned in a first set of queried data resulting from a first query of a first web data source as input parameters in a second query of a second web data source, such that a second set of queried data resulting from the second query is based on the one or more key identifiers returned in the first set of queried data.

12. The system for querying web data as recited in claim 10, wherein the web data source and the additional web data sources from which data is queried are defined in accordance with different data formats.

13. The system for querying web data as recited in claim 10, wherein the web data source and the additional web data sources from which data is queried are located on different networks and are separately owned and maintained.

14. The system for querying web data as recited in claim 1, wherein the QL web service is accessible through a QL web service URL, and wherein a QL statement is embedded within the QL web service URL for execution by the QL web service.

15. The system for querying web data as recited in claim 1, wherein the QL web service is defined to insert, update, or delete data present at the web data source in accordance with specifications received in a QL statement upon execution of the QL statement by the QL web service.

16. A method for querying web data, comprising:
generating a query language (QL) statement defined to identify one or more QL tables respectively associated with one or more web data sources and specify one or more actions to be performed on the one or more web data sources, wherein the QL statement is formatted in accordance with a QL syntax;
embedding the generated QL statement within a universal resource locator (URL) directed to a QL web service;
executing the URL directed to the QL web service within an Internet browser such that the QL statement embedded in the URL is executed by the QL web service;
processing the QL statement through the QL web service, whereby the QL web service accesses the one or more QL tables identified in the QL statement through the Internet and retrieves direction from the one or more QL tables regarding access and retrieval of data from the one or more web data sources respectively associated with the one or more QL tables identified in the QL statement;
based on the direction retrieved from the one or more QL tables, operating the QL web service to access the one or more web data sources respectively associated with the one or more QL tables and perform the one or more actions on the one or more web data source as specified in the QL statement; and
conveying a result of the one or more actions performed on the one or more web data sources by the QL web service to the Internet browser in which the URL directed to the QL web service was executed.

17. The method for querying web data as recited in claim 16, wherein the QL syntax of the QL statement is
SELECT what FROM table WHERE filter [|function]
wherein SELECT specifies that the action to be performed on the one or more web data sources is retrieval of data,
wherein what specifies fields of data within the one or more web data sources to be retrieved,
wherein table specifies the one or more QL tables associated with the one or more web data sources,
wherein filter specifies one or more comparison expressions to filter the data returned from execution of the QL statement, and
wherein function is one or more optional functions to be performed on the data returned from execution of the QL statement prior to conveying the result.

18. The method for querying web data as recited in claim 17, wherein each of the one or more QL tables is specified by a respective QL table name when known within an environment of the QL web service or by a respective URL that accessible through the Internet.

19. The method for querying web data as recited in claim 17, wherein the specified filter is a remote filter that limits result data to that which satisfies an equality between an input key and a literal value, wherein the literal value is either a string value, an integer value, or a float value, and wherein the input key is a data parameter within the one or more web data sources, and wherein the remote filter is applied to data at the one or more web data sources.

20. The method for querying web data as recited in claim 17, wherein the specified filter is a local filter that limits result data to that which satisfies a comparison between a field value and a literal value, wherein the literal value is either a string value, an integer value, or a float value, and wherein the field value specifies a data parameter in the conveyed result, and wherein the local filter is applied to data at the QL web service.

21. The method for querying web data as recited in claim 16, wherein conveying the result of the one or more actions performed on the one or more web data sources by the QL web service includes formatting the data returned from execution of the QL statement in a specified format without regard to any format associated with the data as it exists at the one or more web data sources.

22. The method for querying web data as recited in claim 21, wherein the specified format is an XML format, wherein the XML format specifies XML elements as rows in a tabular results data arrangement and specifies XML sub-elements or XML attributes as columns in the tabular results data arrangement.

23. The method for querying web data as recited in claim 22, wherein the XML format is wrapped in a JSON format envelope having a specified callback function name.

24. The method for querying web data as recited in claim 21, wherein the specified format is a JSON format, wherein the JSON format specifies JSON objects as rows of a tabular results data arrangement and specifies JSON name-value pairs as columns of the tabular results data arrangement.

25. The method for querying web data as recited in claim 24, wherein the JSON format includes a specified callback function name.

26. A method for binding web data to a web data query system, comprising:
creating an structured file that includes information to bind a web data source to the system for querying web data, wherein the information includes:
authentication and security specifications indicating a type of authentication required for the web data query system to access the web data source and indicating whether or not the web data query system is required to access the web data source over a secure connection, and
instructions for how the web data query system should create universal resource locators (URLs) that access data available from the web data source; and
associating a URL with the structured file to enable access of the structured file through the Internet; and
storing the structured file on a computer readable storage medium such that the structured file is accessible through the Internet by way of the URL associated with the structured file.

27. The method for binding web data to a web data query system as recited in claim 26, wherein the instructions for how the web data query system should create URLs that access data available from the web data source includes a web data source URL, and specification of query parameters that are available to access particular data within the web data source.

28. The method for binding web data to a web data query system as recited in claim 26, wherein the information included within the structured file further includes pagination options specifying how the web data query system should traverse through the data available from the web data source.

29. The method for binding web data to a web data query system as recited in claim 26, wherein the information included within the structured file further includes a sample query that is executable by the web data query system to demonstrate how data can be retrieved from the web data source.

30. The method for binding web data to a web data query system as recited in claim 26, wherein the structured file is defined in an XML format.
